(19) United States
(12) Patent Application Publication
(10) Pub. No.: US 2023/0048238 A1
(43) Pub. Date: Feb. 16, 2023

(54) PERSONAL EMULATING DEVICE FOR EMULATING GLOBAL PHONE COMMUNICATION AS DOMESTIC MOBILE COMMUNICATION

(71) Applicant: BC&M CO., LTD., Seoul (KR)

(72) Inventor: Hyung-suk KIM, Seongnam-si (KR)

(21) Appl. No.: 17/976,427

(22) Filed: Oct. 28, 2022

Related U.S. Application Data
(63) Continuation of application No. PCT/KR2020/005722, filed on Apr. 29, 2020.

(51) Int. Cl. H04W 12/06; H04L 9/32

(52) U.S. Cl. CPC H04W 12/06; H04L 9/3228

(57) ABSTRACT

A personal emulating device for emulating global phone communication as domestic mobile communication comprises a Universal Subscriber Identity Module (USIM) authentication unit, an information confirmation unit, an authentication processing unit, and a linking unit. The USIM authentication unit includes: a USIM interface unit which interfaces with a USIM of a designated standard; an antenna unit which transmits and receives radio frequency signals of a designated mobile communication standard to and from a base station in a mobile communication network corresponding to the USIM interfaced to the USIM interface unit; and a radio unit which performs a signal processing operation for transmitting and receiving the radio frequency signals of the designated mobile communication standard to and from the base station in the mobile communication network corresponding to the USIM interfaced to the USIM interface unit.

### TECHNICAL FIELD

The present invention provide a personal emulating device for emulating global phone communication based on the SIP function into domestic mobile communication based on the mobile communication operation to emulate a designated mobile communication operation by interfacing a universal subscriber identity module (USIM) validly issued through a designated mobile communication company, and, upon authentication of a registered mapped and registered state between a mobile phone number provided in the USIM and valid unique identification information registered in a designated authentication server, link the emulated mobile communication operation in real time with a session initiation protocol (SIP) function provided in a program of a user wireless terminal corresponding to the authenticated unique identification information.

### BACKGROUND ART

When a user leaves a domestic region and intends to use a mobile communication terminal used in the domestic region, the user may use the mobile communication terminal used in the domestic region after roaming. However, the above roaming scheme is very expensive because fee is charged by units of call time or data usage. Recently, a roaming fee scheme of charging a flat rate on a daily basis within a designated range of call time or data usage has been also used. This roaming fee scheme does not cost much for a short-term stay of about 2 to 3 days. However, an excessively high fee is charged for a medium-term stay of several weeks to several months.

In order to solve some of the above problems, users may sometimes purchase and use a pocket Wi-Fi or a prepaid USIM in foreign countries. However, the pocket Wi-Fi or the prepaid USIM only provides a flat-rate account for a designated data capacity and a designated period with respect to a data charge, and an expensive roaming fee is charged when a phone call or wireless message (such as SMS, EMS, and MMS) via a telephone switchboard is used.

### DISCLOSURE

### Technical Problem

An object of the present invention is to provides a personal emulating device for emulating global phone communication into domestic mobile communication, which includes: a USIM interface unit for interfacing with a universal subscriber identity module (USIM) of a designated standard; an antenna unit for transmitting and receiving a radio frequency signal of a designated mobile communication standard to and from a base station of a mobile communication network corresponding to the USIM interfaced to the USIM interface unit; a radio unit configured to perform a signal processing operation for transmitting and receiving the radio frequency signal of the designated mobile communication standard to and from the base station of the mobile communication network corresponding to the USIM interfaced to the USIM interface unit; a mobile communication processing unit configured to perform a mobile communication operation procedure equivalent to a mobile communication operation of a mobile communication terminal interfacing with the USIM interfaced to the USIM interface unit; and a communication unit connected to the Internet via a designated Internet access device; and includes: a USIM authentication unit for authenticating whether a valid USIM validly issued through a designated mobile communication company is interfaced to the USIM interface unit; an information confirmation unit, when the valid USIM is interfaced to the USIM interface unit, for confirming identification information including a mobile phone number stored in a designated storage area of the USIM interfaced to the USIM interface unit; an authentication processing unit for providing the mobile phone number (or the identification information including the mobile phone number) of the USIM to a designated authentication server through the communication unit to request authentication whether the mobile phone number of the USIM is mapped and registered with valid unique identification information, and receive an authentication result of authenticating a mapped and registered state between the mobile phone number of the USIM and the valid unique identification information from the authentication server; and a linking processing unit, upon authentication of the mapped and registered status between the mobile phone number of the USIM and the valid unique identification information, for linking a designated SIP operation, which is performed in conjunction with the SIP function of the program of the user wireless terminal corresponding to the authenticated unique identification information and the SIP processing function of the designated communication server, with a designated mobile communication operation of the mobile communication processing unit, or linking a designated mobile communication operation performed through the mobile communication processing unit with a designated SIP operation performed in conjunction with the SIP function of the program of the user wireless terminal corresponding to the authenticated unique identification information and the SIP processing function of the designated communication server.

### Technical Solution

The present invention provides a personal emulating device for emulating global phone communication into domestic mobile communication, which includes: a USIM interface unit for interfacing with a universal subscriber identity module (USIM) of a designated standard; an antenna unit for transmitting and receiving a radio frequency signal of a designated mobile communication standard to and from a base station of a mobile communication network corresponding to the USIM interfaced to the USIM interface unit; a radio unit configured to perform a signal processing operation for transmitting and receiving the radio frequency signal of the designated mobile communication standard to and from the base station of the mobile communication network corresponding to the USIM interfaced to the USIM interface unit; a mobile communication processing unit configured to perform a mobile communication operation procedure equivalent to a mobile communication operation of a mobile communication terminal interfacing with the USIM interfaced to the USIM interface unit; and a communication unit connected to the Internet via a designated Internet access device; and includes a control module including: a USIM authentication unit for authenticating whether a valid USIM validly issued through a designated mobile communication company is interfaced to the USIM interface unit, an information confirmation unit, when the valid USIM is interfaced to the USIM interface unit, for confirming identification information including a mobile phone number stored in a designated storage area of the USIM interfaced to the USIM interface unit, an authentication processing unit for providing the mobile phone number (or the identification information including the mobile phone number) of the USIM to a designated authentication server through the communication unit to request authentication whether the mobile phone number of the USIM is mapped and registered with valid unique identification information, and receive an authentication result of authenticating a mapped and registered state between the mobile phone number of the USIM and the valid unique identification information from the authentication server, and a linking processing unit, upon authentication of the mapped and registered status between the mobile phone number of the USIM and the valid unique identification information, for linking a designated SIP operation, which is performed in conjunction with the SIP function of the program of the user wireless terminal corresponding to the authenticated unique identification information and the SIP processing function of the designated communication server, with a designated mobile communication operation of the mobile communication processing unit, or linking a designated mobile communication operation performed through the mobile communication processing unit with a designated SIP operation performed in conjunction with the SIP function of the program of the user wireless terminal corresponding to the authenticated unique identification information and the SIP processing function of the designated communication server.

According to the present invention, the USIM interface unit performs a selective power on or off function for a USIM inserted into a USIM insertion unit, and an interface function including designated i (i≥1) instruction injection and response reception to implement a USIM function of the USIM when power is applied to the USIM inserted into the USIM insertion unit.

In the present invention, when the valid USIM is interfaced to the USIM interface unit, a combination of the USIM interface unit, the mobile communication processing unit, the radio unit, and the antenna unit emulates a mobile communication terminal to which the USIM is interfaced to a mobile communication network corresponding to the USIM.

In the present invention, when the valid USIM is interfaced to the USIM interface unit, a combination of the USIM interface unit, the mobile communication processing unit, the radio unit, the antenna unit, and the SIP processing function of the communication server virtualizes the program of the user wireless terminal having an SIP function linked to the SIP processing function of the communication server into a mobile communication terminal connected to the mobile communication network in a domestic region which operates a mobile communication network corresponding to the USIM.

In the present invention, a combination of the USIM interface unit, the mobile communication processing unit, the radio unit, the antenna unit, and the SIP processing function of the communication server virtualizes the program of the user wireless terminal into a mobile communication terminal connected to the mobile communication network in a domestic region which operates a mobile communication network corresponding to the USIM regardless of a country or region in which the program of the user wireless terminal is connected to the Internet.

In the present invention, the USIM authentication unit includes a function of authenticating whether the USIM is inserted into the USIM insertion unit of the USIM interface unit.

In the present invention, the USIM authentication unit includes a function of injecting a designated instruction into the USIM inserted into the USIM insertion unit of the USIM interface unit to authenticate whether designated information is answered.

In the present invention, the USIM authentication unit includes a function of authenticating whether information corresponding to the USIM is registered in a home location register (HLR) of a mobile communication network corresponding to the USIM, based on a designated mobile communication procedure through the mobile communication processing unit after the USIM is interfaced to the USIM interface unit.

In the present invention, the valid unique identification information includes unique identification information mapped and registered with the mobile phone number of the USIM and completed in payment of a designated service charge.

In the present invention, the information confirmation unit includes a function of confirming identification information including a country code of the USIM stored in a designated storage area of the USIM interfaced to the USIM interface unit, and the authentication processing unit further includes a function of authenticating whether an Internet access location (or country) accessed through the communication unit matches the country code of the USIM.

In the present invention, the authentication processing unit further includes a function that provides the country code (or identification information including the country code) of the USIM to a designated authentication server through the communication unit to request the authentication server to authenticate whether the Internet access location (or country) of the emulating device (or the Internet access device) matches the country code of the USIM, and receives an authentication result, from the authentication server, of verifying whether the Internet access location (or country) matches the country code of the USIM.

In the present invention, the authentication processing unit further includes a function that receives Internet access information for identifying the Internet access location (or country) of the emulating device (or the Internet access device) from a designated authentication server through the communication unit, and authenticates whether the Internet access location (or country) information corresponding to the Internet access information matches the country code of the USIM.

In the present invention, the information confirmation unit includes a function of confirming identification information including a network code of the USIM stored in a designated storage area of the USIM interfaced to the USIM interface unit, and the authentication processing unit further includes a function of authenticating whether a phone call according to a designated mobile communication phone call standard is allowed through the mobile communication network corresponding to the USIM based on the network code of the USIM.

In the present invention, the authentication processing unit further includes a function that provides the network code (or identification information including the network code) of the USIM to a designated authentication server through the communication unit to request the authentication server to authenticate whether a phone call according to a designated mobile communication phone call standard is allowed through the mobile communication network corresponding to the USIM, and receives an authentication result, from the authentication server, of authenticating whether the phone call according to the designated mobile communication phone call standard is allowed through the mobile communication network corresponding to the USIM.

In the present invention, the authentication processing unit further includes a function that provides the network code (or identification information including the network code) of the USIM to a designated authentication server through the communication unit to receive mobile communication phone call standard information capable of a phone call through the mobile communication network corresponding to the network code of the USIM, and authenticates whether a phone call according to a designated mobile communication phone call standard is allowed through the mobile communication network corresponding to the USIM based on the mobile communication phone call standard information.

In the present invention, the authentication processing unit include a function of authenticating whether a phone call according to a designated mobile communication phone call standard is allowed through the mobile communication network corresponding to the USIM, while linking with a designated mobile communication procedure performed through the mobile communication processing unit after the USIM is interfaced to the USIM interface unit.

In the present invention, the mobile communication operation includes an operation of transmitting a call connection request signal for connecting a call channel to a domestic terminal via the mobile communication network corresponding to the USIM.

In the present invention, when the program of the user wireless terminal provides an SIP-based call origination request information including a designated mobile phone number as a calling number and including a designated phone number of a domestic terminal as a receiving number to the communication server via the Internet, the linking processing unit includes a function of receiving call origination request information corresponding to the SIP-based call origination request information from the communication server through the communication unit.

In the present invention, when the call origination request information is received from the communication server, the authentication processing unit includes a function of authenticating whether the calling number of the call origination request information matches a mobile phone number stored in a designated storage area of the USIM interfaced to the USIM interface unit.

In the present invention, the linking processing unit includes a function of controlling the mobile communication processing unit to perform a mobile communication operation of transmitting a call connection request signal including the mobile phone number of the USIM as a calling number and including a receiving number of the call origination request information as a receiving number configured to connect a call via the mobile communication network corresponding to the USIM.

In the present invention, the mobile communication processing unit includes a function of performing a mobile communication operation of transmitting a call connection request signal including the mobile phone number of the USIM as a calling number and including a receiving number of the call origination request information as a receiving number configured to connect a call via the mobile communication network corresponding to the USIM.

In the present invention, when the domestic terminal corresponding to the receiving number of the call connection request signal receives the call connection request signal, the linking processing unit includes a function of relaying and linking a mobile communication-based call channel connected to a domestic terminal via the mobile communication network, with an Internet-based call channel connected to the program of the user wireless terminal through the SIP processing function of the communication server.

In the present invention, when the domestic terminal corresponding to the receiving number of the call connection request signal receives the call connection request signal, the linking processing unit includes a function of relaying and linking the Internet-based call channel connected to the program of the user wireless terminal through the SIP processing function of the communication server, with the mobile communication-based call channel connected to the domestic terminal via the mobile communication network.

In the present invention, the mobile communication operation includes an operation of receiving a call connection request signal for connecting a call channel from a domestic terminal to a mobile communication terminal corresponding to the mobile phone number of the USIM via the mobile communication network corresponding to the USIM.

In the present invention, the mobile communication processing unit includes a function of receiving a call connection request signal including the mobile phone number of the USIM as a receiving number and including a designated phone number of the domestic terminal as a calling number from the mobile communication network corresponding to the USIM interfaced to the USIM interface unit, and the linking processing unit includes a function of confirming the call connection request signal received through the mobile communication processing unit.

In the present invention, when the call connection request signal including the mobile phone number of the USIM as a receiving number and including a designated phone number of the domestic terminal as a calling number is received from the mobile communication network corresponding to the USIM through the mobile communication processing unit, the authentication processing unit includes a function of authenticating whether the receiving number of the call connection request signal matches a mobile phone number stored in the designated storage area of the USIM interfaced to the USIM interface unit.

In the present invention, the linking processing unit includes a function of providing call reception request information corresponding to the call connection request signal to the communication server through the communication unit, and the communication server performs an SIP processing function for transferring SIP-based call reception request information corresponding to the call reception request information to a program of the user wireless terminal corresponding to the valid unique identification information mapped with the mobile phone number corresponding to the calling number of the call reception request information.

In the present invention, when the program of the user wireless terminal receives the SIP-based call reception request information, the linking processing unit includes a function of relaying and linking the Internet-based call channel connected to the program of the user wireless terminal through the SIP processing function of the communication server, with the mobile communication-based call channel connected to the domestic terminal via the mobile communication network.

In the present invention, when the program of the user wireless terminal receives the SIP-based call reception request information, the linking processing unit includes a function of relaying a mobile communication-based call channel connected to the domestic terminal via the mobile communication network, with the Internet-based call channel connected to the program of the user wireless terminal through the SIP processing function of the communication server.

In the present invention, the mobile communication operation includes an operation of transmitting a wireless message to the domestic terminal via the mobile communication network corresponding to the USIM, and the wireless message includes at least one message among a short message service (SMS), an enhanced messaging service (EMS), and a multimedia message service (MMS) that are transmitted and received via the mobile communication network.

In the present invention, when the program of the user wireless terminal provides SIP-based message information including a designated mobile phone number as a calling number, including a designated domestic phone number as a receiving number, and including a designated message content to the communication server via the Internet, the linking processing unit includes a function of receiving message information corresponding to the SIP-based message information from the communication server through the communication unit.

In the present invention, when the message information is received from the communication server, the authentication processing unit includes a function of authenticating whether the calling number of the message information matches the mobile phone number stored in the designated storage area of the USIM interfaced to the USIM interface unit.

In the present invention, the linking processing unit includes a function of controlling the mobile communication processing unit to perform a mobile communication operation of transmitting a wireless message including the mobile phone number of the USIM as a calling number and the receiving number and the message content of the message information via the mobile communication network corresponding to the USIM.

In the present invention, the mobile communication processing unit includes a function of performing a mobile communication operation of transmitting a wireless message including the mobile phone number of the USIM as a calling number and the receiving number and the message content of the message information via the mobile communication network corresponding to the USIM.

In the present invention, the mobile communication operation includes an operation of receiving a wireless message from a domestic terminal via the mobile communication network corresponding to the USIM, and the wireless message includes at least one message among a short message service (SMS), an enhanced messaging service (EMS), and a multimedia message service (MMS) that are transmitted and received via the mobile communication network.

In the present invention, the mobile communication processing unit includes a function of receiving a wireless message including the mobile phone number of the USIM as a receiving number, including a designated phone number of the domestic terminal as a calling number, and including a designated message content from the mobile communication network corresponding to the USIM interfaced to the USIM interface unit, and the linking processing unit includes a function of confirming the wireless message received through the mobile communication processing unit.

In the present invention, when the wireless message is received including the mobile phone number of the USIM as a receiving number, including a designated phone number of the domestic terminal as a calling number, and including a designated message content from the mobile communication network corresponding to the USIM through the mobile communication processing unit, the authentication processing unit includes a function of authenticating whether the receiving number of the wireless message matches the mobile phone number stored in the designated storage area of the USIM interfaced to the USIM interface unit.

In the present invention, the linking processing unit includes a function of providing message information corresponding to the wireless message to the communication server through the communication unit, and the communication server performs an SIP processing function of transferring SIP-based message reception request information for providing the message information to a program of the user wireless terminal corresponding to the valid unique identification information mapped with the mobile phone number corresponding to the receiving number of the message information.

In the present invention, the SIP-based message reception request information includes an SIP-based notification transferred to the program of the user wireless terminal via the Internet through SIP.

In the present invention, when the program of the user wireless terminal receives the SIP-based message reception request information and is exposed, the communication server includes a function of providing message information including the message content to the program of the user wireless terminal.

### Advantageous Effects

According to the present invention, when a mobile phone number of a valid USIM validly issued through a domestic mobile communication company is mapped with unique identification information linked with completion of payment of a designated service charge, and then the USIM is interfaced to a user emulating device provided at a domestic base, a user wireless terminal is emulated through the emulating device as if being located in a domestic region as long as the user wireless terminal is connected to the Internet wherever the user is present at any place in the world, so that a global phone communication using the program of the user wireless terminal can be processed as domestic mobile communication.

According to the present invention, when a mobile phone number of a valid USIM validly issued through a domestic mobile communication company is mapped with unique identification information linked with completion of payment of a designated service charge, and then the USIM is interfaced to a user emulating device provided at a domestic base, a user wireless terminal is emulated through the emulating device as if being located in a domestic region as long as the user wireless terminal is connected to the Internet wherever the user is present at any place in the world, so that, when the program of the user wireless terminal corresponding to the unique identification information requests a global phone call to the domestic terminal, the emulating device can process the global phone call as a domestic phone call between the user wireless terminal and a domestic terminal located in the domestic region.

According to the present invention, when a mobile phone number of a valid USIM validly issued through a domestic mobile communication company is mapped with unique identification information linked with completion of payment of a designated service charge, and then the USIM is interfaced to a user emulating device provided at a domestic base, a user wireless terminal is emulated through the emulating device as if being located in a domestic region as long as the user wireless terminal is connected to the Internet wherever the user is present at any place in the world, so that, when a global phone call is requested from a domestic terminal located in the domestic region to the user wireless terminal corresponding to unique identification information mapped with a mobile phone number of the USIM interfaced to the emulating device, the emulating device can process the global phone call as a domestic phone call between a domestic terminal and the user wireless terminal located in the domestic region.

According to the present invention, when a mobile phone number of a valid USIM validly issued through a domestic mobile communication company is mapped with unique identification information linked with completion of payment of a designated service charge, and then the USIM is interfaced to a user emulating device provided at a domestic base, the user wireless terminal is emulated through the emulating device as if being located in a domestic region, so that, when the program of the user wireless terminal corresponding to the unique identification information requests a global messaging for sending a wireless message to a domestic terminal, the emulating device can process the global messaging as a domestic messaging between a user wireless terminal located in the domestic region and the domestic terminal.

According to the present invention, when a mobile phone number of a valid USIM validly issued through a domestic mobile communication company is mapped with unique identification information linked with completion of payment of a designated service charge, and then the USIM is interfaced to a user emulating device provided at a domestic base, a user wireless terminal is emulated through the emulating device as if being located in a domestic region as long as the user wireless terminal is connected to the Internet wherever the user is present at any place in the world, so that, when a global messaging for sending a wireless message is requested from a domestic terminal located in the domestic region to the user wireless terminal corresponding to unique identification information mapped with a mobile phone number of the USIM interfaced to the emulating device, the emulating device can process the global messaging as a domestic messaging between a domestic terminal located in a domestic region and a user wireless terminal.

According to the present invention, when a USIM interfaced to a user wireless terminal is interfaced to the emulating device and/or a USIM validly issued to a user is interfaced to the emulating device, the user can send/receive phone calls or send/receive wireless messages to/from domestic terminals by using a mobile phone number of the user USIM while staying abroad for a mid-to-long term.

According to the present invention, the user wireless terminal maintains a state connected to a domestic mobile communication network wherever the user wireless terminal is located in the world, so that the user can conveniently use a domestic banking service or financial service by using the user wireless terminal without blocking an access to the user wireless terminal regardless of the location of the user in the world.

### DESCRIPTION OF DRAWINGS

FIG. 1 is a diagram showing the configuration of an emulation device according to the embodiment of the present invention.

FIG. 2 is a diagram showing the configuration of an emulation system according to the embodiment of the present invention.

FIG. 3 is a diagram showing a process of mapping and registering a mobile phone number with valid unique identification information according to the embodiment of the present invention.

FIG. 4 is a diagram showing a process of authenticating the service provision validity using a USIM interfaced to the emulating device according to the embodiment of the present invention.

FIG. 5 is a diagram showing a process of matching and authenticating the country of the USIM interfaced to the emulating device according to the embodiment of the present invention.

FIG. 6 is a diagram showing a process of matching and authenticating the network of the USIM interfaced to the emulating device according to the embodiment of the present invention.

FIG. 7 is a diagram showing a process of emulating a phone call, which is sent to a domestic terminal through a program of a user wireless terminal located anywhere in the world, into a domestic phone call according to a first embodiment of the present invention.

FIG. 8 is a diagram showing a process of emulating a phone call, which is sent to a user wireless terminal anywhere in the world corresponding to a mobile phone number of USIM through a domestic terminal, into a domestic phone call according to a second embodiment of the present invention.

FIG. 9 is a diagram showing a process of emulating a wireless message, which is sent to a domestic terminal through a program of a user wireless terminal located anywhere in the world, into a domestic messaging according to a third embodiment of the present invention.

FIG. 10 is a diagram showing a process of emulating a wireless message, which is sent to a user wireless terminal anywhere in the world corresponding to a mobile phone number of USIM through a domestic terminal, into a domestic messaging according to a fourth embodiment of the present invention.

### BEST MODE

### Mode for Invention

Hereinafter, the principle of operation of the preferred embodiment of the present invention will be described in detail with reference to the accompanying drawings and description. However, the drawings shown below and the following description are for preferred implementation among various approaches for effectively describing the features of the present invention, and the present invention is not limited only to the following drawings and description.

In other words, the following embodiments correspond to embodiments of a preferred union type among various embodiments according to the present invention. It is clear that, in the following embodiments, an embodiment omitting a specific component (or step), or an embodiment dividing a function implemented in a specific component (or step) into a specific component (or step), an embodiment integrating a function implemented in two or more components (or steps) into any one component (or step), an embodiment replacing an operation sequence of a specific component (or step), and the like are all fall within the scope of the present invention unless otherwise mentioned in the following embodiments. Accordingly, it is clear that various embodiments corresponding to subsets or complementary sets based on the following embodiments may be divided retroactively from the filing date of the present invention.

In addition, in the following description of the embodiments of the present invention, the detailed description of known functions and configurations incorporated herein will be omitted when it possibly makes the subject matter of the present invention unclear unnecessarily. In addition, the terms described below are terms defined in consideration of functions in the present invention, and may vary depending on the intention or custom by a user or operator. Therefore, the definitions will be made based on the contents throughout the specification according to the present invention.

As a result, the technical idea of the present invention shall be determined by the following claims. The following embodiments are merely means for efficiently describing the inventive technical idea of the present invention to those skilled in the art of the present invention.

### Mode for Invention

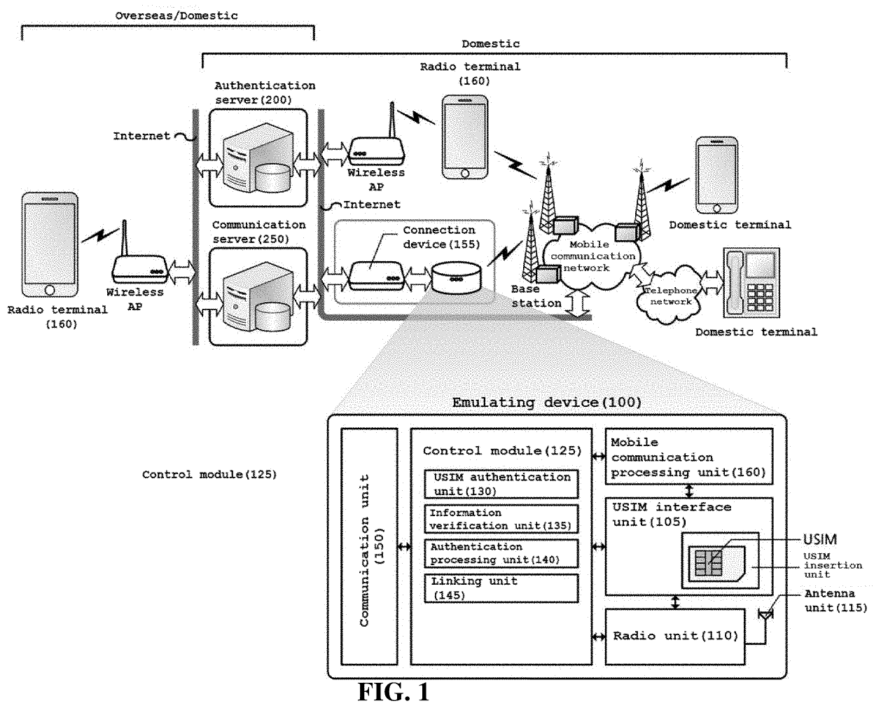

FIG. 1 is a diagram showing the configuration of an emulation device 100 according to the embodiment of the present invention.

More particularly, FIG. 1 shows one embodiment of the configuration of a personal emulating device 100 and the configuration of a system operating the same to emulate a designated mobile communication operation by interfacing a universal subscriber identity module (USIM) validly issued through a designated mobile communication company, and link, when a registered mapped and registered state between a mobile phone number provided in the USIM and valid unique identification information registered in a designated authentication server 200 is authenticated, the emulated mobile communication operation in real time with an SIP function provided in a program of a user wireless terminal 160 corresponding to the authenticated unique identification information, thereby emulating global phone communication based on the SIP function into domestic mobile communication based on the mobile communication operation. Those having ordinary skill in the art may infer various implementation methods (in which, for example, some components are omitted, subdivided, or combined) for the configuration of the emulating device 100 and the configuration of the system with reference to and/or modification of the FIG. 1. However, the present invention is described including all the above inferred implementation methods, and the technical features are not limited only to the implementation method shown in FIG. 1.

The system of the present invention includes: an emulating device 100 that emulates a designated mobile communication operation by interfacing a USIM validly issued through a designated mobile communication company, performs a procedure of authenticating whether the mobile phone number provided in the USIM is mapped and registered with valid unique identification information through a designated authentication server 200, and, when the mapped and registered status between the mobile phone number of the USIM and the unique identification information is authenticated, links the emulated mobile communication operation in real time with an SIP function provided in a program of a user wireless terminal 160 corresponding to the authenticated unique identification information; an authentication server 200 that maps, registers and manages a designated mobile phone number with valid unique identification information completed in payment of a designated service charge, and authenticates, when a valid USIM is interfaced to the emulating device 100, whether the mobile phone number provided in the USIM interfaced to the emulating device 100 is mapped and registered with the valid unique identification information by linking the emulating device 100 via the Internet; a communication server 250 having an SIP function of the program of the user wireless terminal 160 corresponding to the authenticated unique identification information and an SIP processing function of real-time and/or bidirectional linked with a designated mobile communication operation emulated through the emulating device 100, when the mapped and registered status between the mobile phone number of the USIM and the valid unique identification information is authenticated, and includes: a user wireless terminal 160 for driving a program having a designated SIP function linked with the SIP processing function of the communication server 250. Meanwhile, FIG. 1 illustrates the authentication server 200 and the communication server 250 as separate servers for convenience. However, the authentication server 200 and the communication server 250 are named according to functions or roles, and the server embodiment of the present invention is not limited to the embodiment shown in FIG. 1. For example, the present invention may include all of, for example, an embodiment in which the authentication server 200 and the communication server 250 are implemented in one server form, an embodiment in which the authentication server 200 and the communication server 250 are implemented through three or more servers, and some of the functions of the authentication server 200 and the communication server 250 are implemented in the form of a separate server, and others are implemented in the form of software of a pre-established server, or an embodiment in which all of the functions of the authentication server 200 and the communication server 250 are implemented in the form of software of the pre-established server, and the present invention is not limited thereby. Meanwhile, according to the implementation method of the present invention, both of the authentication server 200 and the communication server 250 may be provided in a domestic region. Meanwhile, according to the embodiment of the present invention at least one of the authentication server 200 and the communication server 250 may be provided in a foreign country for each preset country region. For example, the authentication server 200 may be provided in the domestic region, the communication server 250 in charge of the Northeast Asian region including China and Japan may be provided in the domestic region, the communication server 250 in charge of the Southeast Asia region, such as Vietnam or the Philippines, may be provided in Vietnam, and the communication server 250 in charge of European regions, such as the UK or France, may be provided in France. Meanwhile, the authentication server 200 may also be provided for each country region.

The user wireless terminal 160 refers to a generic term for user-owned (or possessed) wireless communication devices that may be connected to the Internet, and preferably, may include at least one wireless communication device of a smartphone, a mobile phone, and a tablet PC that may be connected to the Internet via a wireless AP and/or connected to the Internet via a mobile communication network.

According to the implementation method of the present invention, the user wireless terminal 160 may preferably drive a designated program having a designated SIP function linked with the SIP processing function of the communication server 250.

According to the implementation method of the present invention, the program of the user wireless terminal 160 may include a program driven in the form of an application installed on the user wireless terminal 160, and/or include a program included in a page provided as a browser embedded in the user wireless terminal 160 so as to be driven in the form of a script code executed through the browser.

According to the implementation method of the present invention, when the program of the user wireless terminal 160 is embodied in the form of an application, the program may store and manage designated unique identification information in a designated storage area of the wireless terminal 160, and may extract, after the program is driven, the unique identification information stored in the designated storage area and transmit the extracted unique identification information to the authentication server 200 and/or the communication server 250 according to a designated procedure. Meanwhile, when the program of the user wireless terminal 160 is in the form of an application and/or a script code, the program may receive, after being driven, designated unique identification information and transmit the received unique identification information to the authentication server 200 and/or the communication server 250.

According to the implementation method of the present invention, the user wireless terminal 160 may be located in a domestic region like a country in which a mobile communication network corresponding to the USIM interfaced to the USIM interface unit 105 of the emulating device 100 is operated (hereinafter referred to as ‘domestic’), or may leave the country and be located in a foreign country.

According to the implementation method of the present invention, when a program having a designated SIP function and corresponding to designated unique identification information is driven in the user wireless terminal 160, a payment completion status of a designated service charge is identified through the unique identification information, valid unique identification information completed in payment of a designated service charge is mapped and registered with a designated mobile phone number in a storage medium of the authentication server 200, and a valid USIM having the mobile phone number mapped with the valid unique identification information is interfaced to the USIM interface unit 105 of the emulating device 100, the user, via the Internet through the SIP function of the program driven in the user wireless terminal 160, regardless of whether the user wireless terminal 160 is located in the domestic region or foreign country and/or regardless of whether the user USIM issued to the user is interfaced to the user wireless terminal 160, may send a phone call as a calling number including the mobile phone number of the USIM interfaced to the emulating device 100, and/or may receive a phone call as a receiving number including the mobile phone number of the USIM interfaced to the emulating device 100, and/or may send a wireless message (at least one message of short message service (SMS), enhanced messaging service (EMS), and multimedia message service (MMS)) as a calling number including the mobile phone number of the USIM interfaced to the emulating device 100, and/or may receive a wireless message as a receiving number including the mobile phone number of the USIM interfaced to the emulating device 100.

The emulating device 100 is a generic term for a device that emulates a designated mobile communication operation by interfacing a USIM validly issued through a designated mobile communication company, is connected to the Internet, and, when a designated authentication server 200 authenticates via the Internet that the mobile phone number provided in the USIM is in a mapped and registered state with valid unique identification information, has an SIP function provided in a program of the user wireless terminal 160 corresponding to the authenticated unique identification information and a function of linking the emulated mobile communication operation in real time.

According to the implementation method of the present invention, the emulating device 100 may be purchased by an individual or corporation, connected to an Internet access device 155 provided in a domestic base (for example, home or company), and used in the form of interfacing a USIM validly issued through a designated domestic mobile communication company, and may be transferred or traded between users.

According to the implementation method of the present invention, the USIM interfaced to the emulating device 100 includes any USIM with a standard that may be interfaced to the USIM interface unit 105 of the emulating device 100 among USIMs validly issued through a designated domestic mobile communication company, and the present invention is not limited to a specific USIM.

According to a first embodiment of the present invention for the above USIM, the USIM interfaced to the emulating device 100 may include a USIM having been interfaced to the user wireless terminal 160. In this case, since the USIM having been interfaced to the user wireless terminal 160 is interfaced to the emulating device 100, the user wireless terminal 160 cannot be connected to the mobile network. However, when the connection is allowed to the Internet through a wireless AP and regardless of whether the user wireless terminal 160 is present in a foreign country or domestic region, the user wireless terminal 160 may drive a designated program having a designated SIP function, so as to send/receive a phone call or send/receive a wireless message through the mobile phone number of the USIM interfaced to the emulating device 100.

According to a second embodiment of the present invention for the above USIM, the USIM interfaced to the emulating device 100 may include a separate USIM issued to a user through a designated domestic mobile communication company. In this case, the user wireless terminal 160 may send/receive a phone call or send/receive a wireless message through the mobile phone number of the USIM interfaced to the wireless terminal 160 (provided it is excluded when the USIM interfaced to the user wireless terminal 160 is removed). In addition, when the connection is allowed to the Internet through a wireless AP or a mobile communication network, the user wireless terminal 160 may drive a designated program having a designated SIP function, so as to send/receive a phone call or send/receive a wireless message through the mobile phone number of the USIM interfaced to the emulating device 100. In other words, the same function may be exhibited as allocating a plurality of mobile phone numbers registered under the user's name to one user wireless terminal 160.

According to a third embodiment of the present invention for the above USIM, the USIM interfaced to the emulating device 100 may include a separate USIM issued to a third party (for example, another person or corporation) other than the user through a domestic mobile communication company. In this case, the user wireless terminal 160 may send/receive a phone call or send/receive a wireless message through the mobile phone number of the USIM interfaced to the wireless terminal 160 (provided it is excluded when the USIM interfaced to the user wireless terminal 160 is removed). In addition, when the connection is allowed to the Internet through a wireless AP or a mobile communication network, the user wireless terminal 160 may drive a designated program having a designated SIP function, so as to send/receive a phone call or send/receive a wireless message through the mobile phone number of the USIM interfaced to the emulating device 100. In other words, the same function may be exhibited as allocating a plurality of mobile phone numbers registered under different names to one user wireless terminal 160.

Referring to FIG. 1, the emulating device 100 includes: a USIM interface unit 105 for interfacing a USIM of a designated standard; an antenna unit 115 for transmitting and receiving radio frequency signals of a designated mobile communication standard with a base station of a mobile communication network corresponding to the USIM interfaced to the USIM interface unit 105; a radio unit 110 for performing a signal processing operation for transmitting and receiving the radio frequency signals of the designated mobile communication standard with the base station of the mobile communication network corresponding to the USIM interfaced to the USIM interface unit 105; a mobile communication processing unit 120 for performing a mobile communication operation procedure equivalent to a mobile communication operation of a mobile communication terminal interfacing with the USIM interfaced to the USIM interface unit; and a communication unit 150 connected to the Internet via a designated Internet access device 155.

The USIM interface unit 105 of the emulating device 100 is a generic term of a component to which a valid USIM validly issued through a domestic mobile communication company is inserted to interface with the USIM, and includes a USIM insertion unit into which the USIM is inserted, and a contact terminal (not shown) coming into contact with a contact point (for example, a chip on board (COB) and the like) of the USIM.

According to the implementation method of the present invention, the USIM interface unit 105 may be preferable to perform a function of selectively applying or blocking power to the USIM inserted into the USIM insertion unit, and an interface function including designated i (i≥1) instruction injection and response reception to implement a USIM function of the USIM when power is applied to the USIM inserted into the USIM insertion unit. For example, the USIM interface unit 105 may emulate a rebooting operation of the user wireless terminal 160 to the USIM interfaced to the USIM interface unit 105 through the function of selectively applying or blocking power to the USIM inserted into the USIM insertion unit. Meanwhile, when power is applied to the USIM inserted into the USIM insertion unit, the USIM interface unit 105 may perform a designated interface function including ReSeT (RST) instruction injection and answer-to-reset (ATR) response reception to the USIM, and/or may process at least one of a designated interface function of reading subscriber information (for example, IMSI and ICCID) from the USIM and transmitting the read subscriber information to a designated network operation device (for example, HLR/AuC and the like) of a subscribed mobile communication network through the radio unit 110, and a designated interface function of, when the network operation device generates and transmits the authentication vector with a secret key (K) shared with the USIM, injecting an authentication vector into the USIM through the wireless unit 110, and, when the USIM answers with the authentication response value (RES) by verifying the injected authentication vector through a secret key (K′) receiving an authentication response value (RES) and providing the received RES to a designated network operating device through the wireless unit 110 so as to be authenticated.

The antenna unit 115 of the emulating device 100 is a generic term of a component that transmits and receives designated radio frequency signals to and from a base station of a mobile communication network corresponding to the USIM interfaced to the USIM interface unit 105, and preferably, may transmit the radio frequency signals signal-processed through the designated radio unit 110 to the base station of the mobile communication network and/or receive the radio frequency signals transmitted to the base station of the mobile communication network and provide the received radio frequency signals to the radio unit 110.

The wireless unit 110 of the emulating device 100 is a generic term of a component that performs a signal processing operation for transmitting and receiving the designated radio frequency signals to and from the base station of the mobile communication network corresponding to the USIM interfaced to the USIM interface unit 105, and preferably, may be configured to include at least one RF module, baseband module, and signal processing module, to perform at least one of the procedures of connection, registration, communication, and handoff of a designated mobile communication by linking with the designated mobile communication processing unit 120.

The mobile communication processing unit 120 is a generic term of a component that performs a mobile communication operation procedure equivalent to a mobile communication operation procedure of the user wireless terminal 160 having interfaced to the USIM interfaced to the USIM interface unit 105, so as to perform a mobile communication operation procedure of a mobile communication terminal subscribed to a mobile communication network corresponding to the USIM interfaced to the USIM interface unit 105 by linking a designated wireless unit 110, and the mobile communication operation procedure of the mobile communication terminal may include at least one of a location registration procedure of registering a location via a mobile communication network, a call standby status procedure of maintaining and managing a call standby status, a call origination procedure for originating a call via a mobile communication network, a call connection procedure for processing a call connection request received via the mobile communication network, a wireless messaging procedure for transmitting a wireless message and a wireless messaging procedure for receiving the wireless message.

According to the implementation method of the present invention, when the USIM is interfaced to the USIM interface unit 105, a combination of the USIM interface unit 105, the mobile communication processing unit 120, the radio unit 110, and the antenna unit 115 emulates a mobile communication terminal to which the USIM is interfaced to a mobile communication network corresponding to the USIM.

According to the implementation method of the present invention, when the USIM is interfaced to the USIM interface unit 105, a combination of the USIM interface unit 105, the mobile communication processing unit 120, the radio unit 110, the antenna unit 115, and an SIP processing function of the communication server 250 virtualizes the program of the user wireless terminal 160 linked with the SIP processing function of the communication server 250 into a mobile communication terminal connected to the mobile communication network in a domestic region which operates a mobile communication network corresponding to the USIM, and preferably, may virtualize the user wireless terminal 160 into the mobile communication terminal connected to the mobile communication network in the domestic region which operates the mobile communication network corresponding to the USIM, regardless of a foreign country or region in which the user wireless terminal 160 is connected to the Internet.

According to a first mobile communication operation embodiment of the present invention, the mobile communication processing unit 120 may perform a mobile communication operation including a call origination procedure for originating a call through a mobile communication network corresponding to the USIM by linking the wireless unit 110 based on the USIM inserted into the USIM interface unit 105. Meanwhile, the mobile communication processing unit 120 may perform the call origination procedure by linking with the SIP processing function of the communication server 250 through the control module 125 while linking the radio unit 110 to perform the call origination procedure, and the present invention is not limited thereby.

According to a second mobile communication operation embodiment of the present invention, the mobile communication processing unit 120 may perform a mobile communication operation including a call connection procedure for processing a call connection request received via the mobile communication network corresponding to the USIM by linking the wireless unit 110 based on the USIM inserted into the USIM interface unit 105. Meanwhile, the mobile communication processing unit 120 may perform the call connection procedure by linking with the SIP processing function of the communication server 250 through the control module 125 while linking the radio unit 110 to perform the call connection procedure, and the present invention is not limited thereby.

According to a third mobile communication operation embodiment of the present invention, the mobile communication processing unit 120 may perform a mobile communication operation including a message reception procedure for receiving a designated wireless message through a mobile communication network corresponding to the USIM by linking the wireless unit 110 based on the USIM inserted into the USIM interface unit 105. Meanwhile, the mobile communication processing unit 120 may perform the message reception procedure by linking with the SIP processing function of the communication server 250 through the control module 125 while linking the radio unit 110 to perform the message reception procedure, and the present invention is not limited thereby.

According to a fourth mobile communication operation embodiment of the present invention, the mobile communication processing unit 120 may perform a mobile communication operation including a message sending procedure for sending a designated wireless message through a mobile communication network corresponding to the USIM by linking the wireless unit 110 based on the USIM inserted into the USIM interface unit 105. Meanwhile, the mobile communication processing unit 120 may perform the message sending procedure by linking with the SIP processing function of the communication server 250 through the control module 125 while linking the radio unit 110 to perform the message sending procedure, and the present invention is not limited thereby.

The communication unit 150 of the emulating device 100 is a generic term of a component that connects the emulating device 100 to the Internet, and preferably, may connect the emulating device 100 to an IP-based wired Internet or wireless Internet (for example, the Internet via a wireless LAN and the like). According to the implementation method of the present invention, the communication unit 150 may connect a communication channel to the authentication server 200 and/or the communication server 250 via the Internet.

Referring to FIG. 1, the emulating device 100 includes a control module 125 including: a USIM authentication unit 130 for authenticating whether a valid USIM validly issued through a designated mobile communication company is interfaced to the USIM interface unit 105; an information confirmation unit 135, when the valid USIM is interfaced to the USIM interface unit 150, for confirming identification information including a mobile phone number stored in a designated storage area of the USIM interfaced to the USIM interface unit 105; an authentication processing unit 140 for providing the mobile phone number (or the identification information including the mobile phone number) of the USIM to a designated authentication server 200 through the communication unit 150 to request authentication whether the mobile phone number of the USIM is mapped and registered with valid unique identification information, and receive an authentication result of authenticating a mapped and registered state between the mobile phone number of the USIM and the valid unique identification information from the authentication server 200; and a linking processing unit 145, when the mobile phone number of the USIM is mapped and registered with valid unique identification information, for linking a designated SIP operation performed in conjunction with an SIP function of the program of the user wireless terminal 160 corresponding to the authenticated unique identification information and an SIP processing function of the designated communication server 250 with a designated mobile communication operation of the mobile communication processing unit 120, or linking a designated mobile communication operation performed through the mobile communication processing unit 120 with a designated SIP operation performed in conjunction with the SIP function of the program of the user wireless terminal 160 corresponding to the authenticated unique identification information and the SIP processing function of the designated communication server 250.

The USIM authentication unit 130 of the control module 125 performs one or more authentication procedures for authenticating whether the valid USIM validly issued through a designated mobile communication company is interfaced to the USIM interface unit 105 and operated effectively.

According to a first USIM authentication embodiment of the present invention, the USIM authentication unit 130 may perform a status authentication procedure of authenticating whether a USIM of a designated standard is inserted into the USIM insertion unit of the USIM interface unit 105 by linking the USIM interface unit 105. The USIM may be manufactured in various standards such as a mini SIM card standard (for example, ISO/IEC 7810:2003, ID-000), a micro SIM card standard (for example, ETSI TS 102 221 V9.0.0, Mini-UICC), and a nano SIM card standard (for example, ETSI TS 102 221 V11.0.0). The USIM insertion unit of the USIM interface unit 105 also may be provided in accordance with any one (or two or more) of the above standards. When the USIM insertion unit of the USIM interface unit 105 has the nano SIM card standard, a USIM of a nano SIM card standard is allowed to be inserted into the USIM insertion unit, and a USIM of a mini SIM card standard or micro SIM card standard cannot be inserted. The USIM authentication unit 130 may authenticate whether the USIM corresponding to the standard of the USIM insertion unit is inserted into the USIM insertion unit of the USIM interface unit 105, and then a designated contact point of the USIM and a designated contact terminal of the USIM interface unit 105 maintain an effectively contacted state therebetween.

According to a second USIM authentication embodiment of the present invention, the USIM authentication unit 130 may perform an operation authentication procedure of injecting a designated instruction into the USIM inserted into the USIM insertion unit of the USIM interface unit 105 to authenticate whether designated information is answered. For example, the USIM authentication unit 130 may inject an RST into the USIM through the USIM interface unit 105 to authenticate whether a designated ATR is answered, and/or inject a designated instruction into the USIM to authenticate whether designated information is answered.

According to a third USIM authentication embodiment of the present invention, the USIM authentication unit 130 may perform a network connection authentication procedure of authenticating whether information corresponding to the USIM is registered in a home location register (HLR) of a mobile communication network corresponding to the USIM based on a designated mobile communication procedure through the mobile communication processing unit 120 after the USIM is interfaced to the USIM interface unit 105. For example, the mobile communication processing unit 120 may perform a location registration procedure of registering a location to a mobile communication network corresponding to the USIM interfaced to the USIM interface unit 105, and/or a call standby status procedure of maintaining and managing a call standby status procedure, by linking with the wireless unit 110 after booting the emulating device 100, and the USIM authentication unit 130 may authenticate whether the location registration procedure and/or the call standby status procedure is performed, by linking with the mobile communication processing unit 120.

When the valid USIM is interfaced to the USIM interface unit 150, the information confirmation unit 135 of the control module 125 confirms identification information including a mobile phone number stored in a designated storage area of a valid USIM interfaced to the USIM interface unit 105.

According to the implementation method of the present invention, the information confirmation unit 135 may confirm an international mobile subscriber identity (IMSI) stored in a designated storage area of a valid USIM interfaced to the USIM interface unit 105.

According to the implementation method of the present invention, the IMSI includes a 3-digit mobile country code (MCC), a 2-digit (European standard) or 3-digit (North American standard) mobile network code (MNC), and a mobile subscriber identifier number (MSIN) within 10 digits based on a network provider. For example, the MCC of Republic of Korea is ‘450’ and MNC of SK Telecom is ‘05’. Meanwhile, the MSIN typically refers to a number field corresponding to a mobile phone number. Since the MSIN is a numeric string of 10 digits or less, for example, an MSIN such as ‘1012345678’ corresponds to a mobile phone number commonly known as ‘010-1234-5678’.

The authentication processing unit 140 of the control module 125 configures authentication request information including a mobile phone number of the USIM (for example, a mobile phone number converted from MSIN of IMSI into a designated phone number system) or identification information including the mobile phone number (for example, the above IMSI), and transmits authentication request information including the mobile phone number (or the identification information including the mobile phone number) of the USIM to a designated authentication server 200 through the communication unit 150, to request the authentication server 200 to authenticate whether the mobile phone number of the USIM is in a state mapped and registered with the valid unique identification information.

According to the implementation method of the present invention, when a program in the form of an application is installed in the user wireless terminal 160, and when the application is initially driven after the application is installed (or driven before information is registered), the application may perform a procedure of determining/generating non-overlapping unique identification information for uniquely identifying at least one or two or more combinations of the user, the wireless terminal 160, and the application, to register the non-overlapping unique identification information in the authentication server 200 (or an application server (not shown) in conjunction with the authentication server 200), and the authentication server 200 may store and manage the unique identification information in a designated management DB. Alternatively, the user may perform a procedure of allowing the user to subscribe through at least one of an application type using an application of the user wireless terminal 160, a web type using a browser of the user wireless terminal 160, and a web type using a browser of a separate user terminal (not shown). In this case, the authentication server 200 may register non-overlapping unique identification information inputted through the above app/web type and store and manage the registered non-overlapping unique identification information in a designated management DB to uniquely identify the subscribed user. Meanwhile, the procedure of registering and storing the unique identification information may be processed by linking with a membership registration process for the user. In this case, the authentication server 200 may map the user's personal information acquired through the membership registration process with the unique identification information and store and manage the mapped personal information in a designated management DB.

According to the implementation method of the present invention, while providing (or after providing) the registered unique identification information to the authentication server 200 through at least one of an application type using an application of the user wireless terminal 160, a web type using a browser of the user wireless terminal 160, and a web type using a browser of a separate user terminal, the user may perform a payment procedure for processing payment of a designated service charge for the service of the present invention through at least one of the application type using an application of the user wireless terminal 160, the web type using a browser of the user wireless terminal 160, and the web type using a browser of a separate user terminal. In this case, the authentication server 200 may confirm a payment completion status of a designated service charge for the unique identification information by linking with the payment procedure.

According to the implementation method of the present invention, at a designated time before, during, or after confirming the payment completion status of the designated service charge for the unique identification information, the authentication server 200 registers a mobile phone number corresponding to a valid USIM to interface with the emulating device 100 through at least one of the application type using an application of the user wireless terminal 160, the web type using a browser of the user wireless terminal 160, and the web type using a browser of a separate user terminal. When the payment completion status of the designated service charge for the unique identification information is confirmed, the authentication server 200 performs a procedure of mapping and registering valid unique identification information completed in payment of the designated service charge with a mobile phone number of a valid USIM interfaced to the emulating device 100 into a designated storage medium.

Meanwhile, the authentication server 200 may receive authentication request information including a mobile phone number (or identification information including the mobile phone number) of the USIM interfaced to the emulating device 100 via the Internet from the emulating device 100, authenticate a mapped and registered status between the mobile phone number of the USIM and the valid unique identification information by linking with the storage medium, and then generate result information including a result of authenticating the mapped and registered status between the mobile phone number of the USIM and the valid unique identification information.

Meanwhile, When the authentication server 200 provides the result information generated through the above procedure to the emulating device 100 via the Internet, the authentication processing unit 140 may receive the result information from the authentication server 200, and read the received result information, to confirm the mapped and registered status between the mobile phone number of the USIM and the valid unique identification information.

Meanwhile, the information confirmation unit 135 of the control module 125 may confirm identification information including a country code of the USIM (for example, MCC or the like) stored in a designated storage area of the USIM interfaced to the USIM interface unit 105. In this case, the authentication processing unit 140 of the control module 125 may perform a procedure of authenticating whether an Internet access location (or country) accessed through the communication unit 150 matches the country code of the USIM. In other words, a normal mobile communication terminal may automatically perform a roaming procedure and the like even when the country code of the USIM does not match. However, because the emulating device 100 of the present invention emulates a global phone communication into a domestic mobile communication, it may be preferable to pend the emulation when the country code does not match.

According to a first country authentication embodiment of the present invention, the authentication processing unit 140 may provide a country code (or identification information including the country code) of the USIM to a designated authentication server 200 through the communication unit 150, to request the authentication server 200 to authenticate whether the Internet access location (or country) of the emulating device 100 (or the Internet access device 155) matches the country code of the USIM. In this case, the authentication server 200 may receive authentication request information including a country code (or identification information including the country code) stored in a designated storage area of the USIM interfaced to the emulating device 100 via the Internet from the emulating device 100. Meanwhile, the authentication server 200 may confirm Internet service provider (ISP) information based on an IP address of the emulating device 100 (or the Internet access device 155) to confirm Internet access information for identifying the Internet access location (or country) of the emulating device 100 (or the Internet access device 155), authenticate, based on the Internet access information, whether the Internet access location (or country) of the emulating device 100 (or the Internet access device 155) matches the country code of the USIM, and then generate result information including a result of authenticating whether the Internet access location (or country) of the emulating device 100 (or the Internet access device 155) matches the country code of the USIM.

According to a second country authentication embodiment of the present invention, the authentication processing unit 140 may provide a country code (or identification information including the country code) of the USIM to a designated authentication server 200 through the communication unit 150, to request Internet access information for identifying the Internet access location (or country) of the emulating device 100 (or the Internet access device 155) through the authentication server 200. In this case, the authentication server 200 may receive authentication request information including a country code (or identification information including the country code) stored in a designated storage area of the USIM interfaced to the emulating device 100 via the Internet from the emulating device 100. Meanwhile, the authentication server 200 may confirm ISP information based on an IP address of the emulating device 100 (or the Internet access device 155) to confirm Internet access information for identifying the Internet access location (or country) of the emulating device 100 (or the Internet access device 155), and generate result information including the confirmed Internet access information. In this case, the Internet access information is provided to the emulating device 100 through the result information, and the authentication processing unit 140 may receive result information including Internet access information for identifying the Internet access location (or country) of the emulating device 100 (or the Internet access device 155) from the authentication server 200 through the communication unit 150, and authenticate whether the Internet access location (or country) information corresponding to the Internet access information matches the country code of the USIM.

Meanwhile, when the authentication server 200 provides the result information generated through the above procedure to the emulating device 100 via the Internet, the authentication processing unit 140 may receive the result information from the authentication server 200 and read the received result information and/or perform a designated authentication procedure based on the information included in the result information to confirm whether the Internet access location (or country) accessed through the communication unit 150 matches the country code of the USIM.

Meanwhile, the information confirmation unit 135 of the control module 125 may confirm identification information including a network code of the USIM (for example, MNC, band code or the like) stored in a designated storage area of the USIM interfaced to the USIM interface unit 105. In this case, the authentication processing unit 140 of the control module 125, based on the network code of the USIM, may perform a procedure of authenticating whether a phone call according to a designated mobile communication phone call standard is allowed through the mobile communication network corresponding to the USIM.

According to the implementation method of the present invention, the mobile communication processing unit 120 and/or the wireless unit 110 may be limited to process a phone call of a mobile communication phone call standard. The emulating device 100 of the present invention may be sold to any country in the world, and may be linked with mobile communication networks of any country in the world. However, even when mobile communication phone call standards of some countries develop to LTE, 5G or higher, mobile communication phone call standards of other countries may be 3G or lower. In this case, it may be inappropriate to mount high-priced/high-royalty parts that support higher mobile communication phone call standards in the emulating device 100 sold to countries in which the mobile communication phone call standard is 3G or lower (in other words, it may be inappropriate to purchase an expensive emulating device 100 equipped with the high-priced/high-royalty parts to which a technology that cannot be used from the point of view of a user purchasing the emulating device 100 is applied). In this case, the mobile communication phone call standard of the mobile communication processing unit 120 and/or the radio unit 110 of the emulating device 100 may be limited to a specific mobile communication phone call standard.

In addition, the present invention links a mobile communication phone call with an Internet-based phone call using SIP. When the Internet quality accessible through the user wireless terminal 160 in some countries is lower than a preset standard, no matter how high the mobile communication phone call quality of the country equipped with the emulating device 100 (for example, even when LTE, 5G or higher phone quality is specified), the Internet-based phone call quality connected by the user wireless terminal 160 cannot overcome the limitation of the Internet quality of the country. When the maximum phone call quality of the Internet-based phone call connectable from the user wireless terminal 160 is equal to and lower than the phone call quality of 3G mobile communication based on the mobile communication phone call quality, it may be inappropriate to mount high-priced/high-royalty parts that support higher mobile communication phone call standards in the emulating device 100 (in other words, it may be inappropriate to purchase an expensive emulating device 100 equipped with the high-priced/high-royalty parts to which a technology that cannot be effective from the point of view of a user purchasing the emulating device 100 is applied). In this case, the mobile communication phone call standard of the mobile communication processing unit 120 and/or the radio unit 110 of the emulating device 100 may be limited to a specific mobile communication phone call standard.

As described in the above manner, when the mobile communication phone call standard of the mobile communication processing unit 120 and/or the radio unit 110 of the emulating device 100 is limited to a specific mobile communication phone call standard, the authentication processing unit 140, based on the network code of the USIM, may perform a procedure of authenticating whether the mobile communication phone call standard of the mobile communication processing unit 120 and/or the wireless unit 110 matches the mobile communication phone call standard provided through the mobile communication network corresponding to the USIM.

According to a first mobile communication phone call standard authentication embodiment of the present invention, the authentication processing unit 140 may provide the network code (or identification information including the network code) of the USIM to a designated authentication server 200 through the communication unit 150 to request the authentication server 200 to authenticate whether a phone call according to a designated mobile communication phone call standard is allowed through the mobile communication network corresponding to the USIM. In this case, the authentication server 200 may receive authentication request information including a network code (or identification information including the network code) stored in a designated storage area of the USIM interfaced to the emulating device 100 via the Internet from the emulating device 100. Meanwhile, the authentication server 200 may read the network code of the USIM or query a designated database through the network code of the USIM to confirm mobile communication phone call standard information capable of a phone call through the mobile communication network corresponding to the network code of the USIM, authenticate whether a phone call according to a designated mobile communication phone call standard is allowed through the mobile communication network corresponding to the USIM based on the mobile communication phone call standard information, and then generate result information including a result of authenticating whether a phone call according to a designated mobile communication phone call standard is allowed through the mobile communication network corresponding to the USIM.

According to a second mobile communication phone call standard authentication embodiment of the present invention, the authentication processing unit 140 may provide the network code (or identification information including the network code) of the USIM to a designated authentication server 200 through the communication unit 150 to request mobile communication phone call standard information capable of a phone call through the mobile communication network corresponding to the network code of the USIM through the authentication server 200. In this case, the authentication server 200 may receive authentication request information including a network code (or identification information including the network code) stored in a designated storage area of the USIM interfaced to the emulating device 100 via the Internet from the emulating device 100. Meanwhile, the authentication server 200 may read the network code of the USIM or query a designated database through the network code of the USIM to confirm mobile communication phone call standard information capable of a phone call through the mobile communication network corresponding to the network code of the USIM, and generate result information including the confirmed mobile communication phone call standard information. In this case, the mobile communication phone call standard information is provided to the emulating device 100 through the result information, and the authentication processing unit 140 may receive result information including mobile communication phone call standard information capable of a phone call through the mobile communication network corresponding to the network code of the USIM from the authentication server 200 through the communication unit 150, and authenticate whether a phone call according to a designated mobile communication phone call standard is allowed through the mobile communication network corresponding to the USIM based on the mobile communication phone call standard information.

Meanwhile, when the authentication server 200 provides the result information generated through the above procedure to the emulating device 100 via the Internet, the authentication processing unit 140 may receive the result information from the authentication server 200 and read the received result information and/or perform a designated authentication procedure based on the information included in the result information to confirm whether a phone call according to a designated mobile communication phone call standard is allowed through the mobile communication network corresponding to the USIM.

Meanwhile, according to another embodiment of the present invention, the authentication processing unit 140 also may authenticate whether a phone call according to a designated mobile communication phone call standard is allowed through the mobile communication network corresponding to the USIM by linking with a designated mobile communication procedure performed through the mobile communication processing unit 120 after the USIM is interfaced to the USIM interface unit 105 (for example, a location registration procedure of registering a location via a mobile communication network, a call standby status procedure of maintaining and managing a call standby status, and the like). For example, when the mobile communication processing unit 120 links with a mobile communication network corresponding to the USIM based on the USIM, and a designated mobile communication procedure is successfully performed (for example, when an error does not occur on the mobile network side), the authentication processing unit 140 may authenticate the phone call according to the designated mobile communication phone call standard is allowed through the mobile communication network corresponding to the USIM.

Meanwhile, when at least one authentication procedure, which includes an authentication procedure of authenticating a mapped and registered status between the mobile phone number of the USIM and the valid unique identification information, is performed through the authentication processing unit 140 and the authentication is successful, the linking processing unit 145 performs a procedure of linking a designated SIP operation performed in conjunction with the SIP function of the program of the user wireless terminal 160 corresponding to the authenticated unique identification information and the SIP processing function of the designated communication server 250 with a designated mobile communication operation of the mobile communication processing unit 120, and/or performs a procedure of linking a designated mobile communication operation performed through the mobile communication processing unit 120 with a designated SIP operation performed in conjunction with the SIP function of the program of the user wireless terminal 160 corresponding to the authenticated unique identification information and the SIP processing function of the designated communication server 250.

According to a first embodiment of the present invention, the designated mobile communication operation performed through the mobile communication processing unit 120 may include an operation of transmitting a call connection request signal for connecting a call channel to a domestic terminal via a mobile communication network corresponding to a valid USIM interfaced to the USIM interface unit 105.

When the program driven in the user wireless terminal 160 provides SIP-based call origination request information including a designated mobile phone number as a calling number and including a designated phone number of a domestic terminal as a receiving number to the communication server 250 via the Internet, the communication server 250 receives the SIP-based call origination request information including a designated mobile phone number as a calling number and including a designated phone number of a domestic terminal as a receiving number from the program of the user wireless terminal 160 via the Internet.

Meanwhile, according to the implementation method of the present invention, the communication server 250 may provide the mobile phone number included in the SIP-based call origination request information to the authentication server 200 to request authentication. In this case, the authentication server 200 links with the storage medium to authenticate a mapped and registered status between the mobile phone number included in the SIP-based call origination request information and the valid unique identification information, and provides a result of authenticating the mapped and registered status between the mobile phone number and the valid unique identification information to the communication server 250, and the communication server 250 receives, from the authentication server 200, and reads the result of authenticating the mapped and registered status between the mobile phone number and the valid unique identification information to confirm whether the mobile phone number included in the SIP-based call origination request information is in a state mapped and registered with the valid unique identification information. Meanwhile, according to the implementation method, the process of authenticating whether the mobile phone number included in the SIP-based call origination request information is in a state mapped and registered with the valid unique identification information may be omitted.

Meanwhile, when the mobile phone number included in the SIP-based call origination request information is in a state mapped and registered with the valid unique identification information (this may be omitted), the communication server 250 sends call origination request information corresponding to the SIP-based call origination request information (for example, call origination request information including the mobile phone number of the USIM as a calling number and including a designated phone number of a domestic terminal as a receiving number) to the emulating device 100 interfacing the USIM having the mobile phone number corresponding to the calling number of the SIP-based call origination request information. In this case, the linking processing unit 145 of the control module 125 receives call origination request information corresponding to the SIP-based call origination request information from the communication server 250 through the communication unit 150.

Meanwhile, when the call origination request information is received from the communication server 250 through the linking processing unit 145, the authentication processing unit 140 may authenticate whether the calling number of the call origination request information matches the mobile phone number stored in a designated storage area of the USIM interfaced to the USIM interface unit 105. Meanwhile, according to the implementation method, the process of authenticating whether the calling number of the call origination request information is the mobile phone number of the USIM may be omitted.

Meanwhile, when it is authenticated whether the calling number of the call origination request information is the mobile phone number of the USIM through the authentication processing unit 140 (this may be omitted), the linking processing unit 145 controls to perform a mobile communication operation of transmitting a call connection request signal including the mobile phone number of the USIM as a calling number and including a receiving number of the call origination request information as a receiving number configured to connect a call via the mobile communication network corresponding to the USIM through the mobile communication processing unit 120, and the mobile communication processing unit 120 performs a mobile communication operation of transmitting the call connection request signal including the mobile phone number of the USIM as a calling number and including a receiving number of the call origination request information as a receiving number configured to connect a call via the mobile communication network corresponding to the USIM.

Meanwhile, when the mobile communication operation of transmitting the call connection request signal through the mobile communication processing unit 120 is performed, the linking processing unit 145 confirms whether the domestic terminal corresponding to the receiving number of the call connection request signal receives the call connection request signal by linking with the mobile communication processing unit 120. When the domestic terminal corresponding to the receiving number of the call connection request signal receives the call connection request signal, the linking processing unit 145 may relay and link the mobile communication-based call channel connected to the domestic terminal via the mobile communication network with the Internet-based call channel connected to the program of the user wireless terminal 160 through the SIP processing function of the communication server 250, and/or may relay and link the Internet-based call channel connected to the program of the user wireless terminal 160 through the SIP processing function of the communication server 250 with the mobile communication-based call channel connected to the domestic terminal via the mobile communication network.

According to a second embodiment of the present invention, the designated mobile communication operation performed through the mobile communication processing unit 120 may include an operation of receiving a call connection request signal for connecting a call channel from a domestic terminal to a mobile communication terminal corresponding to the mobile phone number of the USIM via a mobile communication network corresponding to a valid USIM interfaced to the USIM interface unit 105.

According to the implementation method of the present invention, when a call connection request signal including the mobile phone number of the USIM as a receiving number and including a designated phone number of the domestic terminal as a calling number is sent from a domestic terminal connected to a mobile communication network or telephone network in a domestic region in which a mobile communication network corresponding to a valid USIM interfaced to the USIM interface unit 105 is operated, the mobile communication processing unit 120 receives the call connection request signal including the mobile phone number of the USIM as a receiving number and including a designated phone number of the domestic terminal as a calling number from the mobile communication network corresponding to the USIM interfaced to the USIM interface unit 105. In this case, the linking processing unit 145 may confirm the call connection request signal received from the domestic terminal to the mobile communication processing unit 120 via the mobile communication network by linking with the mobile communication processing unit 120.

Meanwhile, according to the implementation method of the present invention, when the linking processing unit 145 confirms the call connection request signal received from the domestic terminal to the mobile communication processing unit 120 via the mobile communication network, the authentication processing unit 140 may authenticate whether the receiving number of the call connection request signal matches the mobile phone number stored in a designated storage area of the USIM interfaced to the USIM interface unit 105. Meanwhile, according to the implementation method, the process of authenticating whether the receiving number of the call connection request signal is the mobile phone number of the USIM may be omitted.

Meanwhile, when the authentication processing unit 140 authenticates whether the receiving number of the call connection request signal is the mobile phone number of the USIM (this may be omitted), the linking processing unit 145 provides call reception request information corresponding to the call connection request signal to the communication server 250 through the communication unit 150 (for example, call reception request information including the mobile phone number of the USIM as a receiving number and including a designated phone number of a domestic terminal as a calling number), and the communication server 250 receives the call reception request information including the mobile phone number of the USIM as a receiving number and including a designated phone number of the domestic terminal as a calling number via the Internet from the emulating device 100.

Meanwhile, according to the implementation method of the present invention, when receiving the call reception request information including the mobile phone number of the USIM as a receiving number and including a designated phone number of the domestic terminal as a calling number from the emulating device 100 via the Internet, the communication server 250 may provide the mobile phone number included in the call reception request information to the authentication server 200 to request authentication. In this case, the authentication server 200 links with the storage medium to authenticate a mapped and registered status between the mobile phone number included in the call reception request information and the valid unique identification information, and provide a result of authenticating the mapped and registered status between the mobile phone number and the valid unique identification information to the communication server 250, and the communication server 250 may receive, from the authentication server 200, and read the result of authenticating the mapped and registered status between the mobile phone number and the valid unique identification information to confirm whether the mobile phone number included in the call reception request information is in a state mapped and registered with the valid unique identification information. Meanwhile, according to the implementation method, the process of authenticating whether the mobile phone number included in the call reception request information is in a state mapped and registered with the valid unique identification information may be omitted.

Meanwhile, when the mobile phone number included in the call reception request information is in a state mapped and registered with the valid unique identification information (this may be omitted), the communication server 250 performs an SIP processing function for transferring SIP-based call reception request information corresponding to the call reception request information to a program of the user wireless terminal 160 corresponding to the valid unique identification information mapped with the mobile phone number corresponding to the receiving number of the call reception request information. According to the implementation method of the present invention, the communication server 250 transmits SIP-based call reception request information corresponding to the call reception request information (for example, SIP-based call reception request information including the mobile phone number of the USIM as a receiving number and including a designated phone number of the domestic terminal as a calling number) to a program of the user wireless terminal 160 corresponding to the unique identification information mapped with the mobile phone number corresponding to the receiving number of the call reception request information via the Internet. In this case, the program of the user wireless terminal 160 receives the SIP-based call reception request information via the Internet, and performs a procedure of receiving the SIP-based call reception request information.

Meanwhile, after transmitting the call reception request information to the communication server 250, the linking processing unit 145 confirms whether the program of the user wireless terminal 160 corresponding to the receiving number of the call reception request information receives the SIP-based call reception request information by linking with the communication server 250. When the program of the user wireless terminal 160 receives the SIP-based call reception request information, the linking processing unit 145 may relay and link the Internet-based call channel connected to the program of the user wireless terminal 160 through the SIP processing function of the communication server 250 with the mobile communication-based call channel connected to the domestic terminal via the mobile communication network, and/or relay and link the mobile communication-based call channel connected to the domestic terminal via the mobile communication network, with the Internet-based call channel connected to the program of the user wireless terminal 160 through the SIP processing function of the communication server 250.

According to a third embodiment of the present invention, the designated mobile communication operation performed through the mobile communication processing unit 120 may include an operation of sending a wireless message to a domestic terminal via a mobile communication network corresponding to a valid USIM interfaced to the USIM interface unit 105. The wireless message may include at least one message among a short message service (SMS), an enhanced messaging service (EMS), and a multimedia message service (MMS) that are transmitted and received via the mobile communication network.

When the program driven in the user wireless terminal 160 provides SIP-based message information including a designated mobile phone number as a calling number, including a designated domestic phone number as a receiving number, and including a designated message content to the communication server 250 via the Internet, the communication server 250 receives the SIP-based message information including a designated mobile phone number as a calling number and including a designated phone number of a domestic terminal as a receiving number from the program of the user wireless terminal 160 via the Internet.

Meanwhile, according to the implementation method of the present invention, the communication server 250 may provide the mobile phone number included in the SIP-based message information to the authentication server 200 to request authentication. In this case, the authentication server 200 links with the storage medium to authenticate a mapped and registered status between the mobile phone number included in the SIP-based message information and the valid unique identification information, and provides a result of authenticating the mapped and registered status between the mobile phone number and the valid unique identification information to the communication server 250, and the communication server 250 may receive, from the authentication server 200, and read the result of authenticating the mapped and registered status between the mobile phone number and the valid unique identification information to confirm whether the mobile phone number included in the SIP-based message information is in a state mapped and registered with the valid unique identification information. Meanwhile, according to the implementation method, the process of authenticating whether the mobile phone number included in the SIP-based message information is in a state mapped and registered with the valid unique identification information may be omitted.

Meanwhile, when the mobile phone number included in the SIP-based message information is in a state mapped and registered with the valid unique identification information (this may be omitted), the communication server 250 transmits message information corresponding to the SIP-based message information (for example, message information including the mobile phone number of the USIM as a calling number, including a designated domestic phone number as a receiving number, and including a designated message content) to the emulating device 100 interfacing the USIM having the mobile phone number corresponding to the calling number of the SIP-based message information. In this case, the linking processing unit 145 of the control module 125 receives the message information corresponding to the SIP-based message information from the communication server 250 through the communication unit 150.

Meanwhile, when the message information is received from the communication server 250 through the linking processing unit 145, the authentication processing unit 140 may authenticate whether the calling number of the message information matches the mobile phone number stored in the designated storage area of the USIM interfaced to the USIM interface unit 105. Meanwhile, according to the implementation method, the process of authenticating whether the calling number of the message information is the mobile phone number of the USIM may be omitted.

Meanwhile, when it is authenticated whether the calling number of the message information is the mobile phone number of the USIM through the authentication processing unit 140 (this may be omitted), the linking processing unit 145 controls to perform a mobile communication operation of transmitting a wireless message including the mobile phone number of the USIM as a calling number and the receiving number and the message content of the message information via the mobile communication network corresponding to the USIM through the mobile communication processing unit 120, and the mobile communication processing unit 120 performs the mobile communication operation of transmitting the wireless message including the mobile phone number of the USIM as a calling number and the receiving number and the message content of the message information via the mobile communication network corresponding to the USIM.

According to a fourth embodiment of the present invention, the designated mobile communication operation performed through the mobile communication processing unit 120 may include an operation of receiving the wireless message from a domestic terminal via the mobile communication network corresponding to the valid USIM interfaced to the USIM interface unit 105. The wireless message may include at least one message among a short message service (SMS), an enhanced messaging service (EMS), and a multimedia message service (MMS) that are transmitted and received via the mobile communication network.

According to the implementation method of the present invention, when the wireless message including the mobile phone number of the USIM as a receiving number, including a designated phone number of the domestic terminal as a calling number, and including a designated message content is sent from a domestic terminal connected to a mobile communication network or telephone network in a domestic region in which a mobile communication network corresponding to a valid USIM interfaced to the USIM interface unit 105 is operated, the mobile communication processing unit 120 receives the wireless message including the mobile phone number of the USIM as a receiving number, including a designated phone number of the domestic terminal as a calling number, and including a designated message content from the mobile communication network corresponding to the USIM interfaced to the USIM interface unit 105. In this case, the linking processing unit 145 may confirm the wireless message received from the domestic terminal to the mobile communication processing unit 120 via the mobile communication network by linking with the mobile communication processing unit 120.

Meanwhile, according to the implementation method of the present invention, when the linking processing unit 145 confirms the wireless message received from the domestic terminal to the mobile communication processing unit 120 via the mobile communication network, the authentication processing unit 140 may authenticate whether the receiving number of the wireless message matches the mobile phone number stored in the designated storage area of the USIM interfaced to the USIM interface unit 105. Meanwhile, according to the implementation method, the process of authenticating whether the receiving number of the wireless message is the mobile phone number of the USIM may be omitted.

Meanwhile, when it is authenticated whether the receiving number of the wireless message is the mobile phone number of the USIM through the authentication processing unit 140 (this may be omitted), the linking processing unit 145 provides message information corresponding to the wireless message to the communication server 250 through the communication unit 150 (for example, message information including the mobile phone number of the USIM as a receiving number, including a designated phone number of a domestic terminal as a calling number, and including a designated message content), and the communication server 250 receives the message information including the mobile phone number of the USIM as a receiving number, including the designated phone number of the domestic terminal as a calling number, and including the designated message content from the emulating device 100 via the Internet.

Meanwhile, according to the implementation method of the present invention, when receiving the message information including the mobile phone number of the USIM as a receiving number, including the designated phone number of the domestic terminal as a calling number, and including the designated message content from the emulating device 100 via the Internet, the communication server 250 may provide the mobile phone number included in the message information to the authentication server 200 to request authentication. In this case, the authentication server 200 links with the storage medium to authenticate a mapped and registered status between the mobile phone number included in the message information and the valid unique identification information, and provides a result of authenticating the mapped and registered status between the mobile phone number and the valid unique identification information to the communication server 250, and the communication server 250 may receive, from the authentication server 200, and read the result of authenticating the mapped and registered status between the mobile phone number and the valid unique identification information to confirm whether the mobile phone number included in the message information is in a state mapped and registered with the valid unique identification information. Meanwhile, according to the implementation method, the process of authenticating whether the mobile phone number included in the message information is in a state mapped and registered with the valid unique identification information may be omitted.

Meanwhile, when the mobile phone number included in the message information is in a state mapped and registered with the valid unique identification information (this may be omitted), the communication server 250 performs an SIP processing function of transferring SIP-based message reception request information for providing the message information to a program of the user wireless terminal 160 corresponding to the valid unique identification information mapped with the mobile phone number corresponding to the receiving number of the message information. According to the implementation method of the present invention, the communication server 250 may transmit the SIP-based message reception request information for providing the message information via the Internet to a program of the user wireless terminal 160 corresponding to the unique identification information mapped with the mobile phone number corresponding to the receiving number of the message information. In this case, the program of the user wireless terminal 160 receives the SIP-based message reception request information via the Internet. Preferably, the SIP-based message reception request information may include an SIP-based notification transferred to the program of the user wireless terminal 160 via the Internet through SIP.

According to the implementation method of the present invention, the communication server 250 transmits the SIP-based message reception request information for providing the message information to the program of the user wireless terminal 160 via the Internet, and then confirms whether the program of the user wireless terminal 160 receives the SIP-based message reception request information and it is exposed through the program of the user wireless terminal 160. When the program of the user wireless terminal 160 receives and exposes the SIP-based message reception request information, the communication server 250 may provide message information including the message content to the program of the user wireless terminal 160. Meanwhile, when the message content is previously included in the SIP-based message reception request information, the process of providing message information including the message content may be omitted.

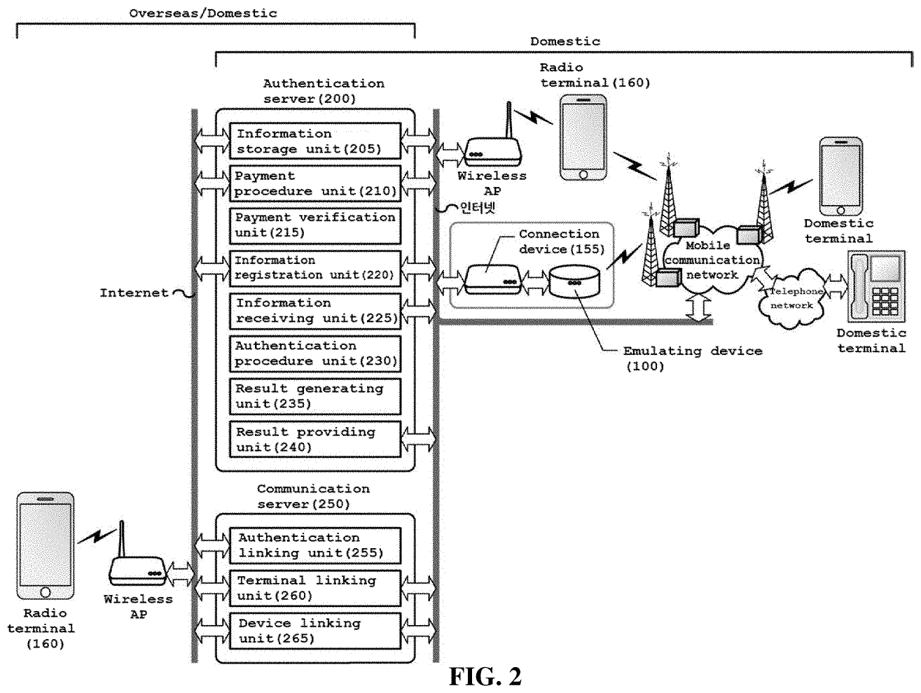

FIG. 2 is a diagram showing the configuration of an emulation system according to the embodiment of the present invention.

More particularly, FIG. 2 shows one embodiment of the configuration of a system, in which, when it is authenticated that the mapped and registered status between the valid unique identification information and the mobile phone number of the USIM interfaced to the personal emulating device 100 for emulating a designated mobile communication operation by interfacing a universal subscriber identity module (USIM) validly issued through a designated mobile communication company, SIP function provided in the program of the user wireless terminal 160 corresponding to the authenticated unique identification information is linked in real time with a function of emulating a designated mobile communication operation in the emulating device 100, thereby emulating global phone communication based on the SIP function to domestic mobile communication based on the mobile communication operation. Those having ordinary skill in the art may infer various implementation methods (in which, for example, some components are omitted, subdivided, or combined) for the configuration of the emulating system with reference to and/or modification of the FIG. 2. However, the present invention is described including all the above inferred implementation methods, and the technical features are not limited only to the implementation method shown in FIG. 2.

Referring to FIG. 2, the authentication server 200 is provided with an information storage unit 205 for registering and storing non-overlapping unique identification information for the service according to the present invention.

When a program in the form of an application is installed in the user wireless terminal 160, and when the application is initially driven after the application is installed (or driven before information is registered), the application performs a procedure of determining/generating non-overlapping unique identification information for uniquely identifying at least one or two or more combinations of the user, the wireless terminal 160, to register non-overlapping unique identification information in the authentication server 200 (or an application server (not shown) in conjunction with the authentication server 200), and the information storage unit 205 may register, store and manage the unique identification information in a designated management DB.

Alternatively, the user may perform a procedure of allowing the user to subscribe through at least one of an application type using an application of the user wireless terminal 160, a web type using a browser of the user wireless terminal 160, and a web type using a browser of a separate user terminal (not shown). In this case, the information storage unit 205 may register non-overlapping unique identification information inputted through the above app/web type and store and manage the registered non-overlapping unique identification information in a designated management DB to uniquely identify the subscribed user.

According to the implementation method of the present invention, the procedure of registering and storing the unique identification information may be processed by linking with a membership registration process for the user. In this case, the information storage unit 205 may map the user's personal information acquired through the membership registration process with the unique identification information and store and manage the mapped personal information in a designated management DB.

Referring to FIG. 2, the authentication server 200 has a payment confirmation unit 215 for confirming a completion of payment of a designated service charge associated with designated unique identification information, and may further include a payment procedure unit 210 for performing a payment procedure of processing the payment of the designated service charge associated with the designated unique identification information.

According to the implementation method of the present invention, while providing (or after providing) the registered unique identification information to the authentication server 200 through at least one of an application type using an application of the user wireless terminal 160, a web type using a browser of the user wireless terminal 160, a web type using a browser of a separate user terminal, the user may link with a designated payment server (not shown) through at least one of an application type using an application of the user wireless terminal 160, a web type using a browser of the user wireless terminal 160, and a web type using a browser of a separate user terminal, to perform a payment procedure for processing payment of a designated service charge for the service of the present invention. In this case, the payment confirmation unit 215 may confirm a payment completion status of a designated service charge for the unique identification information by linking with the payment procedure.

According to the implementation method of the present invention, the payment procedure may be processed through the authentication server 200. In this case, the payment procedure unit 210 may confirm a request for payment of the designated service charge for the designated unique identification information through at least one of an application type using an application of the user wireless terminal 160, a web type using a browser of the user wireless terminal 160, and a web type using a browser of a separate user terminal, perform a payment procedure of processing the payment of the service charge corresponding to the confirmed payment request by linking a designated payment server (not shown), and the payment confirmation unit 215 may confirm a payment completion status of a designated service charge for the unique identification information by linking with the payment procedure.

Referring to FIG. 2, the authentication server 200 includes an information registration unit 220 for performing a procedure of mapping and registering valid unique identification information completed in payment of a designated service charge with a designated mobile phone number in a designated storage medium.

At a designated time before, during, or after confirming the payment completion status of the designated service charge for the unique identification information through the payment confirmation unit 215, the information registration unit 220 registers a mobile phone number corresponding to a valid USIM to interface with the emulating device 100 through at least one of an application type using an application of the user wireless terminal 160, a web type using a browser of the user wireless terminal 160, and a web type using a browser of a separate user terminal.

When the payment confirmation unit 215 confirms the payment completion status of the designated service charge for the unique identification information, the information registration unit 220 performs a procedure of mapping and registering valid unique identification information completed in payment of the designated service charge with a mobile phone number of a valid USIM interfaced to the emulating device 100 into a designated storage medium.

Referring to FIG. 2, the authentication server 200 includes: an information receiving unit 225 for emulating a designated mobile communication operation of the mobile communication terminal by interfacing the USIM, and receiving authentication request information including a mobile phone number (or identification information including the mobile phone number) of the USIM interfaced to the emulating device 100 from the emulating device 100 connected to the Internet through the Internet access device 155 via the Internet; an authentication procedure unit 230 for authenticating a mapped and registered status between the mobile phone number of the USIM and the valid unique identification information by linking with the storage medium; a result generating unit 235 for generating result information including a result of authenticating the mapping registration status between the USIM's mobile phone number and the valid unique identification information; and a results providing unit 240 for providing the result information to the emulating device 100 via the Internet.

When a valid USIM is interfaced to the USIM interface unit 150, the emulating device 100 confirms identification information including a mobile phone number stored in a designated storage area of a valid USIM interfaced to the USIM interface unit 105. The identification information including the mobile phone number may include an international mobile subscriber identity (IMSI) stored in a designated storage area of a valid USIM interfaced to the USIM interface unit 105. Preferably, the IMSI includes a 3-digit mobile country code (MCC), a 2-digit (European standard) or 3-digit (North American standard) mobile network code (MNC), and a mobile subscriber identifier number (MSIN) within 10 digits based on a network provider.

The emulating device 100 configures authentication request information including a mobile phone number of the USIM (for example, a mobile phone number converted from MSIN of IMSI into a designated phone number system) or identification information (for example, the IMSI, etc.) including the mobile phone number, and transmits authentication request information including the mobile phone number (or the identification information including the mobile phone number) of the USIM to the authentication server 200 to request to authenticate whether the mobile phone number of the USIM is in a state mapped and registered with the valid unique identification information. In this case, the information receiving unit 225 may receive authentication request information including a mobile phone number (or identification information including the mobile phone number) of the USIM interfaced to the emulating device 100 via the Internet from the emulating device 100, the authentication procedure unit 230 may authenticate a mapped and registered status between the mobile phone number of the USIM and the valid unique identification information by linking with the storage medium, and the result generating unit 235 may generate result information including a result of authenticating the mapped and registered status between the mobile phone number of the USIM and the valid unique identification information. When the result providing unit 240 provides the result information generated through the above procedure to the emulating device 100 via the Internet, the emulating device 100 may receive the result information from the authentication server 200, and read the received result information to confirm the mapped and registered status between the mobile phone number of the USIM and the valid unique identification information.

Meanwhile, the emulating device 100 may confirm identification information including a country code of the USIM (for example, MCC or the like) stored in a designated storage area of the USIM interfaced to the USIM interface unit 105. In this case, the emulating device 100 may perform a procedure of authenticating whether an Internet access location (or country) accessed through the Internet access device 155 matches the country code of the USIM. In other words, a normal mobile communication terminal may automatically perform a roaming procedure and the like even when the country code of the USIM does not match. However, since the emulating device 100 of the present invention emulates a global phone communication into a domestic mobile communication, it may be preferable to pend the emulation when the country code does not match.

According to a first country authentication embodiment of the present invention, the emulating device 100 may provide a country code (or identification information including the country code) of the USIM to the authentication server 200 to request the authentication server 200 to authenticate whether the Internet access location (or country) of the emulating device 100 (or the Internet access device 155) matches the country code of the USIM. In this case, the information receiving unit 225 may receive authentication request information including a country code (or identification information including the country code) stored in a designated storage area of the USIM interfaced to the emulating device 100 from the emulating device 100 via the Internet. Meanwhile, the authentication procedure unit 230 confirms Internet service provider (ISP) information based on an IP address of the emulating device 100 (or the Internet access device 155) to confirm Internet access information for identifying the Internet access location (or country) of the emulating device 100 (or the Internet access device 155), and authenticate, based on the Internet access information, whether the Internet access location (or country) of the emulating device 100 (or the Internet access device 155) matches the country code of the USIM, and the result generating unit 235 may generate result information including a result of authenticating whether the Internet access location (or country) of the emulating device 100 (or the Internet access device 155) matches the country code of the USIM.

According to a second country authentication embodiment of the present invention, the emulating device 100 may provide a country code (or identification information including the country code) of the USIM to the authentication server 200 to request Internet access information for identifying the Internet access location (or country) of the emulating device 100 (or the Internet access device 155) through the authentication server 200. In this case, the information receiving unit 225 may receive authentication request information including a country code (or identification information including the country code) stored in a designated storage area of the USIM interfaced to the emulating device 100 via the Internet from the emulating device 100. Meanwhile, the authentication procedure unit 230 confirms ISP information based on an IP address of the emulating device 100 (or the Internet access device 155) to confirm Internet access information for identifying the Internet access location (or country) of the emulating device 100 (or the Internet access device 155), and the result generating unit 235 may generate result information including the confirmed Internet access information. In this case, the Internet access information is provided to the emulating device 100 through the result information, and the emulating device 100 may receive result information including the Internet access information for identifying the Internet access location (or country) of the emulating device 100 (or the Internet access device 155) from the authentication server 200, and authenticate whether the Internet access location (or country) information corresponding to the Internet access information matches the country code of the USIM.

Meanwhile, the result providing unit 240 may provide the result information generated through the above procedure to the emulating device 100 via the Internet. In this case, the emulating device 100 may receive the result information from the authentication server 200, and read the received result information and/or perform a designated authentication procedure based on the information included in the result information to confirm whether the Internet access location (or country) of the emulating device 100 (or the Internet access device 155) matches the country code of the USIM.

Meanwhile, the emulating device 100 may confirm identification information including a network code of the USIM (for example, MNC, band code or the like) stored in a designated storage area of the USIM interfaced to the USIM interface unit 105. In this case, the emulating device 100 may perform a procedure of authenticating whether a phone call according to a designated mobile communication phone call standard is allowed through the mobile communication network corresponding to the USIM based on the network code of the USIM.

According to the implementation method of the present invention, the emulating device 100 may be sold to any country in the world, and may be linked with mobile communication networks of any country in the world. However, even when mobile communication phone call standards of some countries develop to LTE, 5G or higher, mobile communication phone call standards of other countries may be 3G or lower. In this case, it may be inappropriate to mount high-priced/high-royalty parts that support higher mobile communication phone call standards in the emulating device 100 sold to countries in which the mobile communication phone call standard is 3G or lower (in other words, it may be inappropriate to purchase an expensive emulating device 100 equipped with the high-priced/high-royalty parts to which a technology that cannot be used from the point of view of a user purchasing the emulating device 100 is applied). In this case, the mobile communication phone call standard to be processed through the emulating device 100 may be limited to a specific mobile communication phone call standard.

In addition, the present invention links a mobile communication phone call with an Internet-based phone call using SIP. When the Internet quality accessible through the user wireless terminal 160 in some countries is lower than a preset standard, and no matter how high the mobile communication phone call quality of the country equipped with the emulating device 100 (for example, even when LTE, 5G or higher phone quality is specified), the Internet-based phone call quality connected by the user wireless terminal 160 cannot overcome the limitation of the Internet quality of the country. When the maximum phone call quality of the Internet-based phone call connectable from the user wireless terminal 160 is equal to and lower than the phone call quality of 3G mobile communication based on the mobile communication phone call quality, it may be inappropriate to mount high-priced/high-royalty parts that support higher mobile communication phone call standards in the emulating device 100 (in other words, it may be inappropriate to purchase an expensive emulating device 100 equipped with the high-priced/high-royalty parts to which a technology that cannot be effective from the point of view of a user purchasing the emulating device 100 is applied). In this case, the mobile communication phone call standard to be processed through the emulating device 100 may be limited to a specific mobile communication phone call standard.

As described in the above manner, when the mobile communication phone call standard of the emulating device 100 is limited to a specific mobile communication phone call standard, the emulating device 100 may, based on the network code of the USIM, perform a procedure of authenticating whether the mobile communication phone call standard that can be processed through the emulating device 100 matches the mobile communication phone call standard provided through the mobile communication network corresponding to the USIM.

According to a first mobile communication phone call standard authentication embodiment of the present invention, the emulating device 100 may provide the network code (or identification information including the network code) of the USIM to the authentication server 200 to request the authentication server 200 to authenticate whether the phone call according to a designated mobile communication phone call standard is allowed through the mobile communication network corresponding to the USIM. In this case, the information receiving unit 225 may receive authentication request information including a network code (or identification information including the network code) stored in a designated storage area of the USIM interfaced to the emulating device 100 from the emulating device 100 via the Internet. Meanwhile, the authentication procedure unit 230 may read the network code of the USIM or query a designated database through the network code of the USIM to confirm mobile communication phone call standard information capable of a phone call through the mobile communication network corresponding to the network code of the USIM, authenticate, based on the mobile communication phone call standard information, whether a phone call according to a designated mobile communication phone call standard is allowed through the mobile communication network corresponding to the USIM, and then generate result information including a result of authenticating whether a phone call according to a designated mobile communication phone call standard is allowed through the mobile communication network corresponding to the USIM.

According to a second mobile communication phone call standard authentication embodiment of the present invention, the emulating device 100 may provide the network code (or identification information including the network code) of the USIM to the authentication server 200 to request mobile communication phone call standard information capable of a phone call through the mobile communication network corresponding to the network code of the USIM through the authentication server 200. In this case, the information receiving unit 225 may receive authentication request information including a network code (or identification information including the network code) stored in a designated storage area of the USIM interfaced to the emulating device 100 from the emulating device 100 via the Internet. Meanwhile, the authentication procedure unit 230 may read the network code of the USIM or query a designated database through the network code of the USIM to confirm mobile communication phone call standard information capable of a phone call through the mobile communication network corresponding to the network code of the USIM, and generate result information including the confirmed mobile communication phone call standard information. In this case, the mobile communication phone call standard information is provided to the emulating device 100 through the result information, the emulating device 100 may receive result information including mobile communication phone call standard information capable of a phone call through the mobile communication network corresponding to the network code of the USIM from the authentication server 200, and authenticate, based on the mobile communication phone call standard information, whether a phone call according to a designated mobile communication phone call standard is allowed through the mobile communication network corresponding to the USIM.

Meanwhile, the result providing unit 240 may provide the result information generated through the above procedure to the emulating device 100 via the Internet. In this case, the emulating device 100 may receive the result information from the authentication server 200, and read the received result information and/or perform a designated authentication procedure based on the information included in the result information to confirm whether a phone call according to a designated mobile communication phone call standard is allowed through the mobile communication network corresponding to the USIM.

Meanwhile, according to another embodiment of the present invention, the emulating device 100 may also link with a designated mobile communication procedure performed through the emulating device 100 after the USIM is interfaced to the USIM interface unit 105 (for example, a location registration procedure of registering a location via a mobile communication network, a call standby status procedure of maintaining and managing a call standby status, and the like), so as to authenticate whether a phone call according to a designated mobile communication phone call standard is allowed through the mobile communication network corresponding to the USIM. For example, when the emulating device 100 links with a mobile communication network corresponding to the USIM based on the USIM, and a designated mobile communication procedure is successfully performed (for example, when an error does not occur on the mobile network side), the emulating device 100 may authenticate the phone call according to the designated mobile communication phone call standard is allowed through the mobile communication network corresponding to the USIM.

Meanwhile, when at least one authentication procedure, which includes an authentication procedure of authenticating a mapped and registered status between the mobile phone number of the USIM and the valid unique identification information, is performed and the authentication is successful, the emulating device 100 performs a procedure of linking a designated SIP operation performed in conjunction with the SIP function of the program of the user wireless terminal 160 corresponding to the authenticated unique identification information and the SIP processing function of the designated communication server 250, with a designated mobile communication operation, and/or performs a procedure of linking a designated mobile communication operation with a designated SIP operation performed in conjunction with the SIP function of the program of the user wireless terminal 160 corresponding to the authenticated unique identification information and the SIP processing function of the designated communication server 250.

Referring to FIG. 2, the communication server 250 includes: a terminal linking unit 260, upon authentication of the mapped and registered status between the mobile phone number of the USIM and the valid unique identification information, for performing an SIP processing function linking with an SIP function of the program of the user wireless terminal 160 corresponding to the authenticated unique identification information; and a device linking unit 265 for performing the SIP processing function of linking with the SIP function of the emulating device 100 interfacing the USIM having the mobile phone number mapped with the authenticated unique identification information, and includes: an authentication linking unit 255 for confirming a mapped and registered status between a designated mobile phone number and valid unique identification information in order to perform a designated SIP processing function.

According to a first embodiment of the present invention, a designated mobile communication operation performed by the emulating device 100 may include an operation of transmitting a call connection request signal for connecting a call channel to a domestic terminal via the mobile communication network corresponding to a valid USIM interfaced to the USIM interface unit 105.

When the program driven in the user wireless terminal 160 provides SIP-based call origination request information including a designated mobile phone number as a calling number and including a designated phone number of a domestic terminal as a receiving number to the communication server 250 via the Internet, the terminal linking unit 260 receives the SIP-based call origination request information including a designated mobile phone number as a calling number and including a designated phone number of a domestic terminal as a receiving number from the program of the user wireless terminal 160 via the Internet.

Meanwhile, according to the implementation method of the present invention, the authentication linking unit 255 may provide the mobile phone number included in the SIP-based call origination request information to the authentication server 200 to request authentication. In this case, the authentication procedure unit 230 of the authentication server 200 may link with the storage medium to authenticate a mapped and registered status between the mobile phone number included in the SIP-based call origination request information and the valid unique identification information, and provide a result of authenticating the mapped and registered status between the mobile phone number and the valid unique identification information to the communication server 250, and the authentication linking unit 255 may receive, from the authentication server 200, and read the result of authenticating the mapped and registered status between the mobile phone number and the valid unique identification information to confirm whether the mobile phone number included in the SIP-based call origination request information is in a state mapped and registered with the valid unique identification information. Meanwhile, according to the implementation method, the process of authenticating whether the mobile phone number included in the SIP-based call origination request information is in a state mapped and registered with the valid unique identification information may be omitted.

Meanwhile, when the mobile phone number included in the SIP-based call origination request information is in a state mapped and registered with the valid unique identification information (this may be omitted), the device linking unit 265 transmits call origination request information corresponding to the SIP-based call origination request information (for example, call origination request information including the mobile phone number of the USIM as a calling number and including a designated phone number of the domestic terminal as a receiving number) to the emulating device 100 interfacing the USIM having the mobile phone number corresponding to the calling number of the SIP-based call origination request information. In this case, the emulating device 100 receives call origination request information corresponding to the SIP-based call origination request information from the communication server 250.

Meanwhile, when receiving the call origination request information from the communication server 250, the emulating device 100 may authenticate whether the calling number of the call origination request information matches the mobile phone number stored in the designated storage area of the USIM interfaced to the USIM interface unit 105. Meanwhile, according to the implementation method, the process of authenticating whether the calling number of the call origination request information is the mobile phone number of the USIM may be omitted.

Meanwhile, when it is authenticated whether the calling number of the call origination request information is the mobile phone number of the USIM (this may be omitted), the emulating device 100 performs a mobile communication operation of transmitting the call connection request signal including the mobile phone number of the USIM as a calling number and including a receiving number of the call origination request information as a receiving number configured to connect a call via the mobile communication network corresponding to the USIM.

Meanwhile, the device linking unit 265 links with the emulating device 100 after transmitting the SIP-based call origination request information to the emulating device 100 to confirm whether the domestic terminal corresponding to the receiving number of the call connection request signal receives the call connection request signal through the emulating device 100. When the domestic terminal corresponding to the receiving number of the call connection request signal receives the call connection request signal, the device linking unit 265 performs an SIP processing procedure of relaying and linking an Internet-based call channel connected to the emulating device 100 with an Internet-based call channel connected to the program of the user wireless terminal 160, and the terminal linking unit 260 performs an SIP processing procedure of relaying and linking the Internet-based call channel connected to the program of the user wireless terminal 160 with the Internet-based call channel connected to the emulating device 100.

According to a second embodiment of the present invention, a designated mobile communication operation performed by the emulating device 100 may include an operation of receiving a call connection request signal for connecting a call channel from a domestic terminal to a mobile communication terminal corresponding to the mobile phone number of the USIM via a mobile communication network corresponding to a valid USIM interfaced to the USIM interface unit 105.

According to the implementation method of the present invention, when a call connection request signal including the mobile phone number of the USIM as a receiving number and including a designated phone number of the domestic terminal as a calling number is sent from a domestic terminal connected to a mobile communication network or telephone network in a domestic region in which a mobile communication network corresponding to a valid USIM interfaced to the USIM interface unit 105 is operated, the emulating device 100 may receive a call connection request signal including the mobile phone number of the USIM as a receiving number and including a designated phone number of the domestic terminal as a calling number from the mobile communication network corresponding to the USIM interfaced to the USIM interface unit 105.

Meanwhile, according to the implementation method of the present invention, when the call connection request signal received from the domestic terminal via the mobile communication network is confirmed, the emulating device 100 may authenticate whether the receiving number of the call connection request signal matches the mobile phone number stored in a designated storage area of the USIM interfaced to the USIM interface unit 105. Meanwhile, according to the implementation method, the process of authenticating whether the receiving number of the call connection request signal is the mobile phone number of the USIM may be omitted.

Meanwhile, when it is authenticated whether the receiving number of the call connection request signal is the mobile phone number of the USIM (this may be omitted), the emulating device 100 provides call reception request information corresponding to the call connection request signal (for example, call reception request information including the mobile phone number of the USIM as a receiving number and including a designated phone number of the domestic terminal as a calling number) to the communication server 250, and the device linking unit 265 receives the call reception request information including the mobile phone number of the USIM as a receiving number and including a designated phone number of the domestic terminal as a calling number from the emulating device 100 via the Internet.

Meanwhile, according to the implementation method of the present invention, when the call reception request information including the mobile phone number of the USIM as a receiving number and including a designated phone number of the domestic terminal as a calling number is received from the emulating device 100 via the Internet, the authentication linking unit 255 may provide the mobile phone number included in the call reception request information to the authentication server 200 to request authentication. In this case, the authentication procedure unit 230 of the authentication server 200 may link with the storage medium to authenticate a mapped and registered status between the mobile phone number included in the call reception request information and the valid unique identification information, and provide a result of authenticating the mapped and registered status between the mobile phone number and the valid unique identification information to the communication server 250, and the authentication linking unit 255 may receive, from the authentication server 200, and read the result of authenticating the mapped and registered status between the mobile phone number and the valid unique identification information to confirm whether the mobile phone number included in the call reception request information is in a state mapped and registered with the valid unique identification information. Meanwhile, according to the implementation method, the process of authenticating whether the mobile phone number included in the call reception request information is in a state mapped and registered with the valid unique identification information may be omitted.

Meanwhile, when the mobile phone number included in the call reception request information is in a state mapped and registered with the valid unique identification information (this may be omitted), the terminal linking unit 260 performs an SIP processing function for transferring SIP-based call reception request information corresponding to the call reception request information to a program of the user wireless terminal 160 corresponding to the valid unique identification information mapped with the mobile phone number corresponding to the receiving number of the call reception request information. According to the implementation method of the present invention, the terminal linking unit 260 transmits SIP-based call reception request information corresponding to the call reception request information (for example, SIP-based call reception request information including the mobile phone number of the USIM as a receiving number and including a designated phone number of the domestic terminal as a calling number) to a program of the user wireless terminal 160 corresponding to the unique identification information mapped with the mobile phone number corresponding to the receiving number of the call reception request information via the Internet. In this case, the program of the user wireless terminal 160 receives the SIP-based call reception request information via the Internet, and performs a procedure of receiving the SIP-based call reception request information.

Meanwhile, the terminal linking unit 260 transmits the SIP-based call reception request information to the program of the user wireless terminal 160, and then confirms whether the program of the user wireless terminal 160 receives the SIP-based call reception request information. When the program of the user wireless terminal 160 receives the SIP-based call reception request information, the device linking unit 265 may transmit a result that the program of the user wireless terminal 160 receives the SIP-based call reception request information to the emulating device 100 through a designated SIP processing function. Meanwhile, when the program of the user wireless terminal 160 receives the SIP-based call reception request information, the terminal linking unit 260 performs an SIP processing procedure of relaying and linking the Internet-based call channel connected to the program of the user wireless terminal 160 with the Internet-based call channel connected to the emulating device 100, and the device linking unit 265 performs the SIP processing procedure of relaying and linking an Internet-based call channel connected to the emulating device 100 with an Internet-based call channel connected to the program of the user wireless terminal 160.

According to a third embodiment of the present invention, a designated mobile communication operation performed by the emulating device 100 may include an operation of sending a wireless message to a domestic terminal via a mobile communication network corresponding to a valid USIM interfaced to the USIM interface unit 105. The wireless message may include at least one message among a short message service (SMS), an enhanced messaging service (EMS), and a multimedia message service (MMS) that are transmitted and received via the mobile communication network.

When the program driven in the user wireless terminal 160 provides SIP-based message information including a designated mobile phone number as a calling number, including a designated domestic phone number as a receiving number, and including a designated message content to the communication server 250 via the Internet, the terminal linking unit 260 receives the SIP-based message information including a designated mobile phone number as a calling number and including a designated phone number of a domestic terminal as a receiving number from the program of the user wireless terminal 160 via the Internet.

Meanwhile, according to the implementation method of the present invention, the authentication linking unit 255 may provide the mobile phone number included in the SIP-based message information to the authentication server 200 to request authentication. In this case, the authentication procedure unit 230 of the authentication server 200 may link with the storage medium to authenticate a mapped and registered status between the mobile phone number included in the SIP-based message information and the valid unique identification information, and provide a result of authenticating the mapped and registered status between the mobile phone number and the valid unique identification information to the communication server 250, and the authentication linking unit 255 may receive, from the authentication server 200, and read the result of authenticating the mapped and registered status between the mobile phone number and the valid unique identification information to confirm whether the mobile phone number included in the SIP-based message information is in a state mapped and registered with the valid unique identification information. Meanwhile, according to the implementation method, the process of authenticating whether the mobile phone number included in the SIP-based message information is in a state mapped and registered with the valid unique identification information may be omitted.

Meanwhile, when the mobile phone number included in the SIP-based message information is in a state mapped and registered with the valid unique identification information (this may be omitted), the device linking unit 265 transmits message information corresponding to the SIP-based message information (for example, message information including a mobile phone number of the USIM as a calling number, including a designated domestic phone number as a receiving number, and including a designated message content) to the emulating device 100 interfacing the USIM having the mobile phone number corresponding to the calling number of the SIP-based message information. In this case, the emulating device 100 receives the message information corresponding to the SIP-based message information from the communication server 250.

Meanwhile, when the message information is received from the communication server 250, the emulating device 100 may authenticate whether the calling number of the message information matches the mobile phone number stored in the designated storage area of the USIM interfaced to the USIM interface unit 105. Meanwhile, according to the implementation method, the process of authenticating whether the calling number of the message information is the mobile phone number of the USIM may be omitted.

Meanwhile, when it is authenticated whether the calling number of the message information is the mobile phone number of the USIM (this may be omitted), the emulating device 100 performs the mobile communication operation of transmitting the wireless message including the mobile phone number of the USIM as a calling number and the receiving number and the message content of the message information via the mobile communication network corresponding to the USIM.

According to a fourth embodiment of the present invention, a designated mobile communication operation performed by the emulating device 100 may include an operation of receiving the wireless message from a domestic terminal via the mobile communication network corresponding to the valid USIM interfaced to the USIM interface unit 105. The wireless message may include at least one message among a short message service (SMS), an enhanced messaging service (EMS), and a multimedia message service (MMS) that are transmitted and received via the mobile communication network.

According to the implementation method of the present invention, when the wireless message including the mobile phone number of the USIM as a receiving number, including a designated phone number of the domestic terminal as a calling number, and including a designated message content is sent from a domestic terminal connected to a mobile communication network or telephone network in a domestic region in which a mobile communication network corresponding to a valid USIM interfaced to the USIM interface unit 105 is operated, the emulating device 100 may receive the wireless message including the mobile phone number of the USIM as a receiving number, including a designated phone number of the domestic terminal as a calling number, and including a designated message content from the mobile communication network corresponding to the USIM interfaced to the USIM interface unit 105.

Meanwhile, according to the implementation method of the present invention, when the wireless message is received from the domestic terminal via the mobile communication network, the emulating device 100 may authenticate whether the receiving number of the wireless message matches the mobile phone number stored in the designated storage area of the USIM interfaced to the USIM interface unit 105. Meanwhile, according to the implementation method, the process of authenticating whether the receiving number of the wireless message is the mobile phone number of the USIM may be omitted.

Meanwhile, when it is authenticated whether the receiving number of the wireless message is the mobile phone number of the USIM (this may be omitted), the emulating device 100 provides message information corresponding to the wireless message (for example, the message information including the mobile phone number of the USIM as a receiving number, including a designated phone number of the domestic terminal as a calling number, and including a designated message content) to the communication server 250, and the device linking unit 265 receives the message information including the mobile phone number of the USIM as a receiving number, including a designated phone number of the domestic terminal as a calling number, and including a designated message content from the emulating device 100 via the Internet.

Meanwhile, according to the implementation method of the present invention, when receiving the message information including the mobile phone number of the USIM as a receiving number, including a designated phone number of the domestic terminal as a calling number, and including a designated message content from the emulating device 100 via the Internet, the authentication linking unit 255 may provide the mobile phone number included in the message information to the authentication server 200 to request authentication. In this case, the authentication procedure unit 230 of the authentication server 200 may link with the storage medium to authenticate a mapped and registered status between the mobile phone number included in the message information and the valid unique identification information, and provide a result of authenticating the mapped and registered status between the mobile phone number and the valid unique identification information to the communication server 250, and the authentication linking unit 255 may receive, from the authentication server 200, and read the result of authenticating the mapped and registered status between the mobile phone number and the valid unique identification information to confirm whether the mobile phone number included in the message information is in a state mapped and registered with the valid unique identification information. Meanwhile, according to the implementation method, the process of authenticating whether the mobile phone number included in the message information is in a state mapped and registered with the valid unique identification information may be omitted.

Meanwhile, when the mobile phone number included in the message information is in a state mapped and registered with the valid unique identification information (this may be omitted), the terminal linking unit 260 performs an SIP processing function of transferring SIP-based message reception request information for providing the message information to a program of the user wireless terminal 160 corresponding to the valid unique identification information mapped with the mobile phone number corresponding to the receiving number of the message information. According to the implementation method of the present invention, the terminal linking unit 260 may transmit the SIP-based message reception request information for providing the message information to a program of the user wireless terminal 160 corresponding to the unique identification information mapped with the mobile phone number corresponding to the receiving number of the message information via the Internet. In this case, the program of the user wireless terminal 160 receives the SIP-based message reception request information via the Internet. Preferably, the SIP-based message reception request information may include an SIP-based notification transferred to the program of the user wireless terminal 160 via the Internet through SIP.

According to the implementation method of the present invention, the terminal linking unit 260 transmits the SIP-based message reception request information for providing the message information to the program of the user wireless terminal 160 via the Internet, and then confirms whether the program of the user wireless terminal 160 receives the SIP-based message reception request information, and it is exposed through the program of the user wireless terminal 160. When the program of the user wireless terminal 160 receives and exposes the SIP-based message reception request information, the terminal linking unit 260 may provide message information including the message content to the program of the user wireless terminal 160. Meanwhile, when the message content is previously included in the SIP-based message reception request information, the process of providing message information including the message content may be omitted.

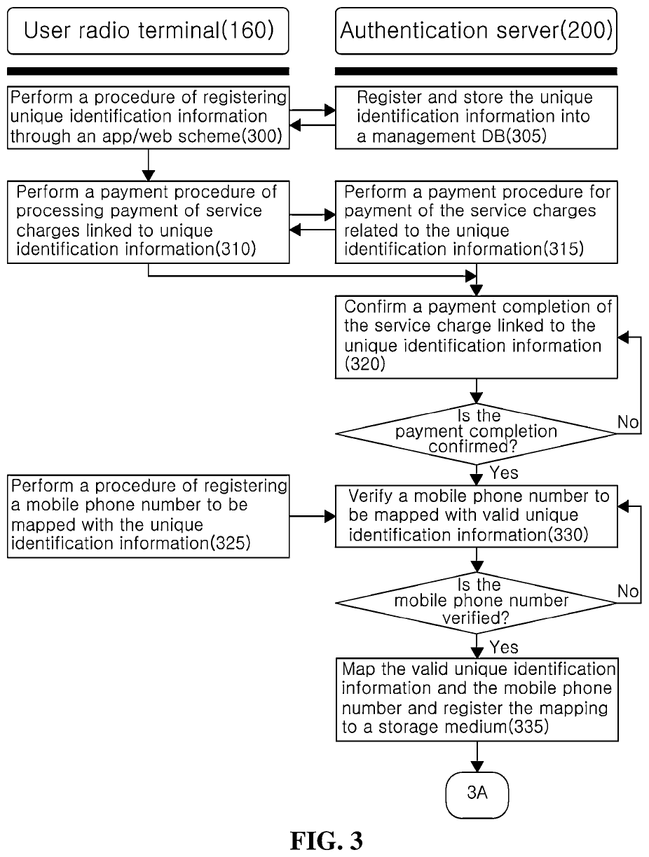

FIG. 3 is a diagram showing a process of mapping and registering a mobile phone number with valid unique identification information according to the embodiment of the present invention.

More particularly, FIG. 3 shows a process of mapping and registering valid unique identification information completed in payment of a designated service charge, with a mobile phone number of a USIM to be interfaced to the user emulator device into a designated storage medium. Those having ordinary skill in the art may infer various implementation methods (in which, for example, some steps are omitted or a sequence is changed) for the above process with reference to and/or modification of the FIG. 3. However, the present invention is described including all the above inferred implementation methods, and the technical features are not limited only to the implementation method shown in FIG. 3.

Referring to FIG. 3, the user performs a procedure of registering unique identification information through an application scheme and/or web scheme by using the user wireless terminal 160 or a separate user terminal (300), and the authentication server 200 registers and stores the unique identification information into a management DB (300).

Meanwhile, the user performs a payment procedure of processing a payment of a service charge in conjunction with the unique identification information (for example, a charge using a service according to the present invention by interfacing the USIM to the user emulator device) (305), by using the user wireless terminal 160 or a separate user terminal. The payment process may be performed through a designated payment server without intervening the authentication server 200, or may be processed by intervening the authentication server 200 (315), and the authentication server 200 confirms a payment completion of the service charge associated with the unique identification information (320) while linking with at least one payment process.

At a designated time before, during, or after completing the payment of the service charge associated with the unique identification information, the user performs a procedure of registering a mobile phone number to be mapped with the unique identification information, by using the user wireless terminal 160 or a separate user terminal (325). Meanwhile, when the payment completion of the service charge associated with the unique identification information is confirmed, the authentication server 200 confirms the mobile phone number to be mapped with the valid unique identification information completed in payment of the service charge (330).

When the mobile phone number is confirmed, the authentication server 200 maps and registers the confirmed mobile phone number with the valid unique identification information completed in payment of the service charge into a designated storage medium (335).

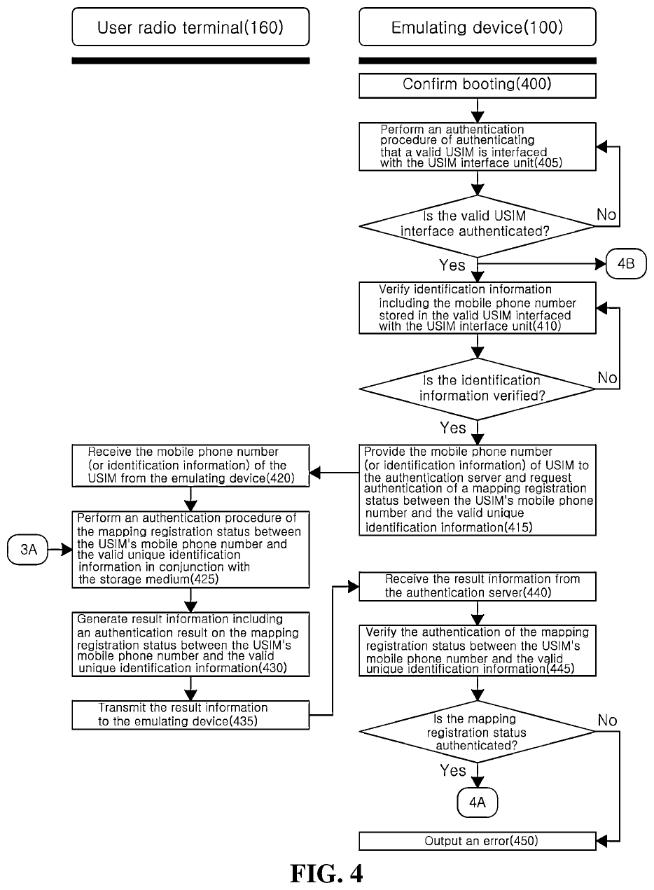

FIG. 4 is a diagram showing a process of authenticating the service provision validity using a USIM interfaced to the emulating device 100 according to the embodiment of the present invention.

More particularly, FIG. 4 shows a process of authenticating the validity of the USIM interfaced to the emulating device 100, and authenticating a mapped and registered status between the mobile phone number of the USIM and the valid unique identification information completed in payment of a designated service charge. Those having ordinary skill in the art may infer various implementation methods (in which, for example, some steps are omitted or a sequence is changed) for the above process with reference to and/or modification of the FIG. 4. However, the present invention is described including all the above inferred implementation methods, and the technical features are not limited only to the implementation method shown in FIG. 4.

Referring to FIG. 4, when a booting of the emulating device 100 is confirmed (400), the emulating device 100 performs an authentication procedure of authenticating whether a valid USIM validly issued through a designated mobile communication company is interfaced to the USIM interface unit 105 (405). Preferably, the emulating device 100 may perform an authentication procedure including at least one of procedures of authenticating whether the USIM is inserted into a USIM insertion unit of the USIM interface unit 105, and/or authenticating whether designated information is answered after injecting a designated instruction into the USIM inserted into the USIM insertion unit of the USIM interface unit 105, and/or authenticating whether information corresponding to the USIM is registered in an HLR of a mobile communication network corresponding to the USIM based on the designated mobile communication procedure after the USIM is interfaced to the USIM interface unit 105.

When the valid USIM is interfaced to the USIM interface unit 105, the emulating device 100 confirms identification information including a mobile phone number stored in a designated storage area of the USIM interfaced to the USIM interface unit 105 (410). When the identification information including the mobile phone number of the USIM is confirmed, the emulating device 100 provides authentication request information including the mobile phone number (or the identification information including the mobile phone number) of the USIM to request to authenticate whether the mobile phone number of the USIM is mapped and registered with valid unique identification information (415).

The authentication server 200 receives authentication request information including the mobile phone number of the USIM (or identification information including the mobile phone number) from the emulating device 100 via the Internet (420), and links with the storage medium to perform an authentication procedure of authenticating a mapped and registered state between the mobile phone number of the USIM and the valid unique identification information (425). The authentication server 200 generates result information including a result of authenticating the mapped and registered status between the mobile phone number of the USIM and the valid unique identification information (430), and transmits the result information to the emulating device 100 via the Internet (435).

Meanwhile, the emulating device 100 receive the result information from the authentication server 200 via the Internet (440), and confirms authentication of a mapped and registered status between the mobile phone number of the USIM and the valid unique identification information, based on the result information (445).

When the mapped and registered status between the mobile phone number of the USIM and the valid unique identification information is not authenticated, the emulating device 100 outputs designated error information (450), and according to the implementation method, may transmit error information to the authentication server 200.

Meanwhile, when the mapped and registered status between the mobile phone number of the USIM and the valid unique identification information is authenticated, the emulating device 100 may link a designated SIP operation performed in conjunction with the SIP function of the program of the user wireless terminal 160 corresponding to the authenticated unique identification information and the SIP processing function of the designated communication server 250 with a designated mobile communication operation of the mobile communication processing unit 120, and/or link a designated mobile communication operation performed through the mobile communication processing unit 120 with a designated SIP operation performed in conjunction with the SIP function of the program of the user wireless terminal 160 corresponding to the authenticated unique identification information and the SIP processing function of a designated communication server 250.

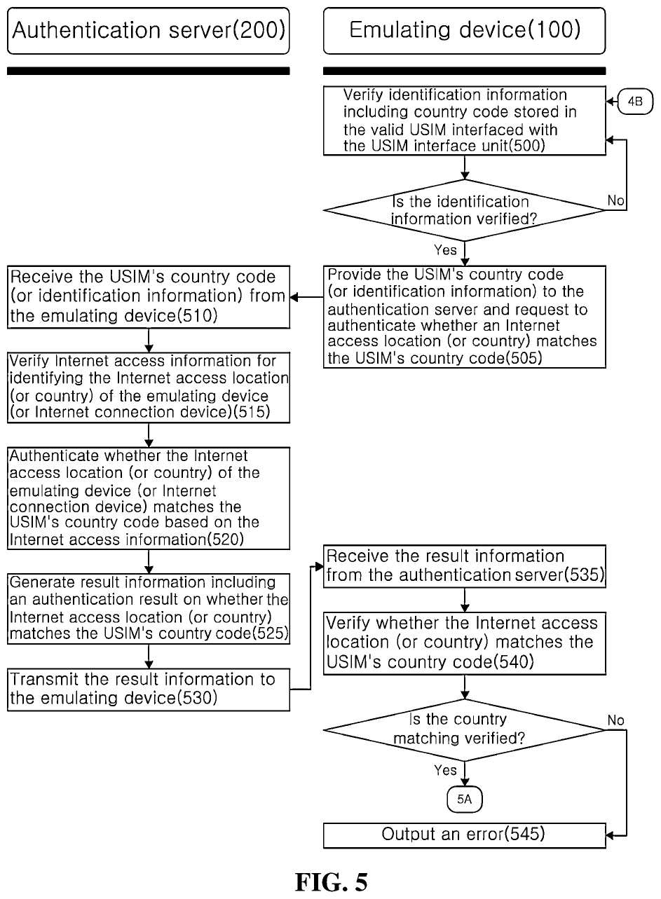

FIG. 5 is a diagram showing a process of matching and authenticating the country of the USIM interfaced to the emulating device 100 according to the embodiment of the present invention.

More particularly, FIG. 5 shows a process of authenticating whether a country code of the USIM interfaced to the emulating device 100 matches an Internet access location (or country) of the emulating device 100 (or the Internet access device 155). Those having ordinary skill in the art may infer various implementation methods (in which, for example, some steps are omitted or a sequence is changed) for the above process with reference to and/or modification of the FIG. 5. However, the present invention is described including all the above inferred implementation methods, and the technical features are not limited only to the implementation method shown in FIG. 5.

Referring to FIG. 5, when the status in which the valid USIM is interfaced to the USIM interface unit 105 is authenticated through the process of FIG. 4, the emulating device 100 confirms identification information including a country code stored in a designated storage area of the USIM interfaced to the USIM interface unit 105 (500). When the identification information including the country code of the USIM is confirmed, the emulating device 100 provides authentication request information including the country code (or the identification information including the country code) of the USIM to request to authenticate whether the Internet access location (or country) of the emulating device 100 (or the Internet access device 155) matches the country code of the USIM (505). Meanwhile, the authentication request information may be the authentication request information of FIG. 4, or may include separate authentication request information.

The authentication server 200 receives the authentication request information including the country code (or the identification information including the country code) of the USIM (510) from the emulating device 100 via the Internet, confirms Internet access information for identifying the Internet access location (or country) of the emulating device 100 (or the Internet access device 155 used for Internet access of the emulating device 100) (515), and performs, based on the Internet access information, an authentication procedure of authenticating whether the Internet access location (or country) of the emulating device 100 (or the Internet access device 155) matches the country code of the USIM (520). The authentication server 200 generates result information including a result of authenticating whether the Internet access location (or country) of the emulating device 100 (or the Internet access device 155) matches the country code of the USIM (525), and transmits the result information to the emulating device 100 via the Internet (530). Meanwhile, the result information may be the result information of FIG. 4, or may include separate result information.

Meanwhile, the emulating device 100 receives the result information from the authentication server 200 via the Internet (535), and confirms whether the Internet access location (or country) of the emulating device 100 (or the Internet access device 155 used for Internet access of the emulating device 100) matches the country code of the USIM (540). Meanwhile, according to another embodiment of the present invention, the process of authenticating whether the Internet access location (or country) of the emulating device 100 (or the Internet access device 155 used for Internet access of the emulating device 100) matches the country code of the USIM may be performed through the emulating device 100, and the present invention is not limited thereby.

When the Internet access location (or country) of the emulating device 100 (or the Internet access device 155 used for Internet access of the emulating device 100) does not match the country code of the USIM, the emulating device 100 outputs designated error information (545), and according to the implementation method, may transmit error information to the authentication server 200.

Meanwhile, when the Internet access location (or country) of the emulating device 100 (or the Internet access device 155 used for Internet access of the emulating device 100) matches the country code of the USIM, the emulating device 100 may link a designated SIP operation performed in conjunction with the SIP function of the program of the user wireless terminal 160 corresponding to the authenticated unique identification information and the SIP processing function of the designated communication server 250 with a designated mobile communication operation of the mobile communication processing unit 120, and/or link a designated mobile communication operation performed through the mobile communication processing unit 120 with a designated SIP operation performed in conjunction with the SIP function of the program of the user wireless terminal 160 corresponding to the authenticated unique identification information and the SIP processing function of a designated communication server 250.

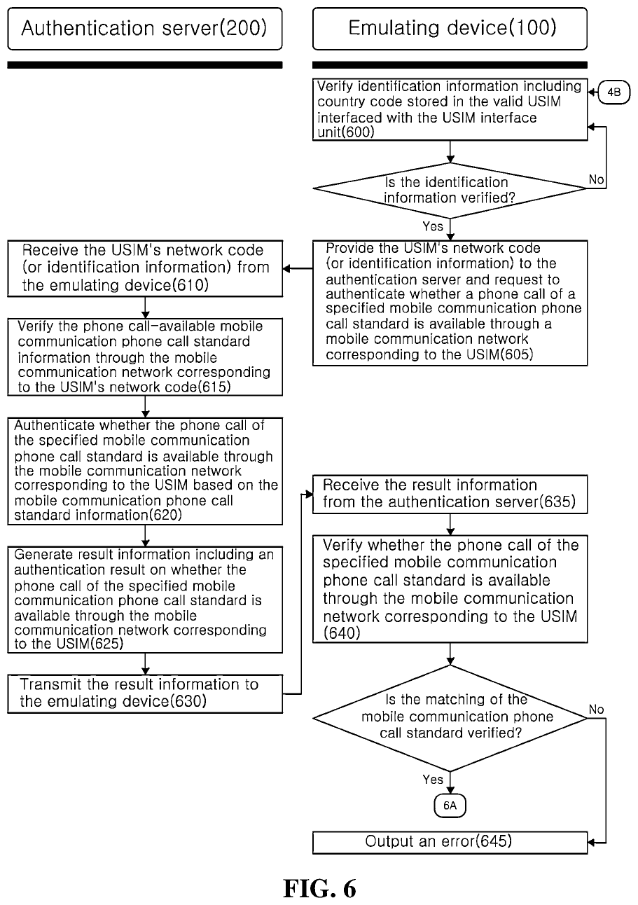

FIG. 6 is a diagram showing a process of matching and authenticating the network of the USIM interfaced to the emulating device 100 according to the embodiment of the present invention.

More particularly, FIG. 6 shows a process of authenticating whether a phone call according to a designated mobile communication phone call standard is allowed through the mobile communication network corresponding to the USIM, by using the network code of the USIM interfaced to the emulating device 100. Those having ordinary skill in the art may infer various implementation methods (in which, for example, some steps are omitted or a sequence is changed) for the above process with reference to and/or modification of the FIG. 6. However, the present invention is described including all the above inferred implementation methods, and the technical features are not limited only to the implementation method shown in FIG. 6.

Referring to FIG. 6, when the status in which the valid USIM is interfaced to the USIM interface unit 105 is authenticated through the process of FIG. 4, the emulating device 100 confirms identification information including a network code stored in a designated storage area of the USIM interfaced to the USIM interface unit 105 (600). When the identification information including the network code of the USIM is confirmed, the emulating device 100 provides authentication request information including the network code (or the identification information including the network code) of the USIM, to request to authentication whether a phone call of a designated mobile communication phone call standard (for example, a mobile communication phone call standard set to the emulating device 100) is allowed through the mobile communication network corresponding to the USIM (605). Meanwhile, the authentication request information may be the authentication request information of FIG. 4, or may include separate authentication request information.

The authentication server 200 receives the authentication request information including the network code (or identification information including the network code) of the USIM from the emulating device 100 via the Internet (610), confirms the mobile communication phone call standard information capable of a phone call through the mobile communication network corresponding to the network code of the USIM (615), and performs an authentication procedure of authenticating whether the phone call according to a designated mobile communication phone call standard is allowed through the mobile communication network corresponding to the USIM based on the mobile communication phone call standard information (620). The authentication server 200 generates result information including a result of authenticating whether the phone call of the designated mobile communication phone call standard is allowed through the mobile communication network corresponding to the USIM (625), and transmits the result information to the emulating device 100 via the Internet (630). Meanwhile, the result information may be the result information of FIG. 4, or may include separate result information.

Meanwhile, the emulating device 100 receives the result information from the authentication server 200 via the Internet (635), and confirms whether the phone call according to a designated mobile communication phone call standard is allowed through the mobile communication network corresponding to the USIM (640). Meanwhile, according to another embodiment of the present invention, the process of authenticating whether a phone call according to a designated mobile communication phone call standard is allowed through the mobile communication network corresponding to the USIM may be performed through the emulating device 100, and the present invention is not limited thereby.

When the phone call according to a designated mobile communication phone call standard is not allowed through the mobile communication network corresponding to the USIM, the emulating device 100 outputs designated error information (645), and according to the implementation method, may transmit error information to the authentication server 200.

Meanwhile, when the phone call according to a designated mobile communication phone call standard is allowed through the mobile communication network corresponding to the USIM, the emulating device 100 may link a designated SIP operation performed in conjunction with the SIP function of the program of the user wireless terminal 160 corresponding to the authenticated unique identification information and the SIP processing function of the designated communication server 250 with a designated mobile communication operation of the mobile communication processing unit 120, and/or link a designated mobile communication operation performed through the mobile communication processing unit 120 with a designated SIP operation performed in conjunction with the SIP function of the program of the user wireless terminal 160 corresponding to the authenticated unique identification information and the SIP processing function of a designated communication server 250.

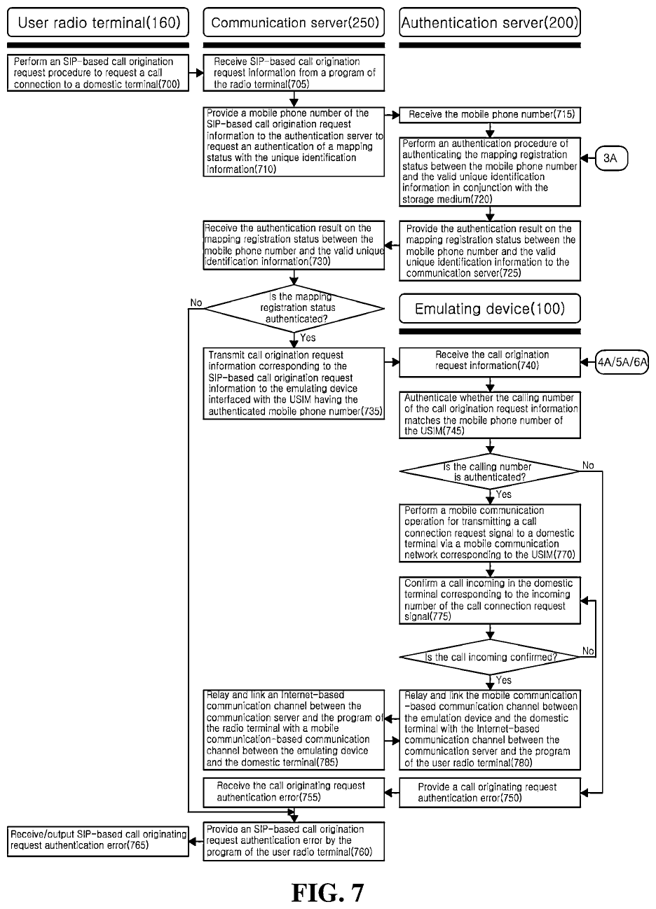

FIG. 7 is a diagram showing a process of emulating a phone call, which is sent to a domestic terminal through a program of a user wireless terminal 160 located anywhere in the world, into a domestic phone call according to a first embodiment of the present invention.

More particularly, FIG. 7 shows a process, when a program of the user wireless terminal 160 located anywhere in the world requests a global phone call to a domestic terminal located in the domestic region, of emulating the global phone call as a domestic phone call between a user wireless terminal 160 located in the domestic region and the domestic terminal through the emulating device 100 provided at a domestic base and interfaced to a valid USIM. Those having ordinary skill in the art may infer various implementation methods (in which, for example, some steps are omitted or a sequence is changed) for the above process with reference to and/or modification of the FIG. 7. However, the present invention is described including all the above inferred implementation methods, and the technical features are not limited only to the implementation method shown in FIG. 7.

Referring to FIG. 7, when the program of the user wireless terminal 160 connected to the Internet anywhere in the world performs the SIP-based call origination request procedure for requesting a call connection to the domestic terminal (700), the communication server 250 receives the SIP-based call origination request information from the program of the user wireless terminal 160 (705), and provides the mobile phone number corresponding to the calling number of the SIP-based call origination request information to the authentication server 200, to request to authenticate a mapped and registered status between the mobile phone number and valid unique identification information (710).

The authentication server 200 receives the mobile phone number (715), links with the storage medium to perform an authentication procedure of authenticating the mapped and registered status between the mobile phone number included in the SIP-based call origination request information and the valid unique identification information (720), and then provides a result of authenticating the mapped and registered status between the mobile phone number and the valid unique identification information to the communication server 250 (725).

The communication server 250 receives the result of authenticating the mapped and registered status between the mobile phone number and the valid unique identification information from the authentication server 200 (730). When the mapped and registered status between the mobile phone number and the valid unique identification information is not authenticated, the communication server 250 provides an authentication error on the SIP-based call origination request to the program of the user wireless terminal 160 (760), and the program of the user wireless terminal 160 receives and outputs the authentication error on the SIP-based call origination request (765).

Meanwhile, when the mapped and registered status between the mobile phone number and the valid unique identification information is authenticated, the communication server 250 transmits the call origination request information corresponding to the SIP-based call origination request information to the emulating device 100 interfacing the USIM having the mobile phone number corresponding to the calling number of the SIP-based call origination request information via the Internet (735).

The emulating device 100 subject to a designated authentication procedure receives the call origination request information from the communication server 250 via the Internet (740), and performs an authentication procedure of authenticating whether the calling number of the call origination request information matches the mobile phone number stored in the designated storage area of the USIM interfaced to the USIM interface unit 105 (745). When the calling number of the call origination request information does not match the mobile phone number of the USIM, the emulating device 100 provides an authentication error on the call origination request to the communication server 250 (750), and the communication server 250 receives the authentication error on the call origination request (755). The communication server 250 provides the authentication error on the SIP-based call origination request to the program of the user wireless terminal 160, based on the authentication error on the call origination request (760), and the program of the user wireless terminal 160 receives and outputs the authentication error on the SIP-based call origination request (765).

Meanwhile, when the calling number of the call origination request information matches the mobile phone number of the USIM, the emulating device 100 performs a mobile communication operation of transmitting the call connection request signal including the mobile phone number of the USIM as a calling number and including a receiving number of the call origination request information as a receiving number configured to connect a call via the mobile communication network corresponding to the USIM (770).

Meanwhile, the emulating device 100 confirms whether the domestic terminal corresponding to the receiving number of the call connection request signal receives the call connection request signal (755). When the domestic terminal corresponding to the receiving number of the call connection request signal receives the call connection request signal, the emulating device 100 performs a procedure of relay and link a mobile communication-based call channel connected to the emulating device 100 and the domestic terminal via the mobile communication network with an Internet-based call channel between the communication server 250 and the program of the user wireless terminal 160 (780), and the communication server 250 also performs the procedure of relaying and linking the Internet-based communication channel between the program of the communication server 250 and the wireless terminal 160 with the mobile communication-based call channel between the emulating device 100 and the domestic terminal (785).

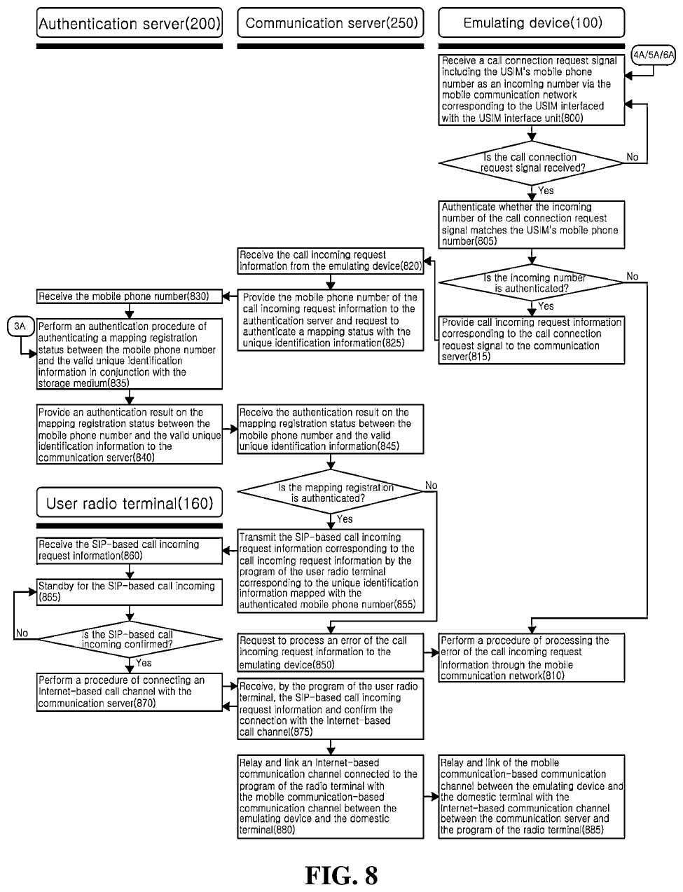

FIG. 8 is a diagram showing a process of emulating a phone call, which is sent to a user wireless terminal anywhere in the world corresponding to a mobile phone number of USIM through a domestic terminal 160, into a domestic phone call according to a second embodiment of the present invention.

More particularly, FIG. 8 shows a process, when a global phone call is requested from a domestic terminal located in a domestic region to a user wireless terminal 160 anywhere in the world corresponding to a mobile phone number of the USIM interfaced to the emulating device 100, of emulating the global phone call as a domestic phone call between the domestic terminal located in the domestic region and a user wireless terminal 160 through the emulating device 100 provided at a domestic base and interfaced to a valid USIM. Those having ordinary skill in the art may infer various implementation methods (in which, for example, some steps are omitted or a sequence is changed) for the above process with reference to and/or modification of the FIG. 8. However, the present invention is described including all the above inferred implementation methods, and the technical features are not limited only to the implementation method shown in FIG. 8.

Referring to FIG. 8, when a call connection request signal including the mobile phone number of the USIM interfaced to the emulating device 100 as a receiving number and including a designated phone number of the domestic terminal as a calling number is sent from the domestic terminal located in the domestic region, the emulating device 100 subject to a designated authentication procedure receives the call connection request signal including the mobile phone number of the USIM as a receiving number via the mobile communication network corresponding to the USIM interfaced to the USIM interface unit 105 (800).

When the call connection request signal is received, the emulating device 100 performs an authentication procedure of authenticating whether the receiving number of the call connection request signal matches the mobile phone number stored in the designated storage area of the USIM interfaced to the USIM interface unit 105 (805). When the receiving number of the call connection request signal does not match the mobile phone number of the USIM, the emulating device 100 performs an error processing procedure of the call connection request signal through the mobile communication network corresponding to the USIM (810).

Meanwhile, when the receiving number of the call connection request signal matches the mobile phone number of the USIM, the emulating device 100 provides call reception request information corresponding to the call connection request signal to the communication server 250 via the Internet (815).

The communication server 250 receives the call reception request information including the mobile phone number of the USIM as a receiving number and including a designated phone number of the domestic terminal as a calling number from the emulating device 100 via the Internet (820), and provides the mobile phone number included in the call reception request information to the authentication server 200, to request to authenticate a mapped and registered status between the mobile phone number and valid unique identification information (825).

The authentication server 200 receives the mobile phone number (830), links with the storage medium to perform an authentication procedure of authenticating the mapped and registered status between the mobile phone number included in the call reception request information and the valid unique identification information (835), and then provides a result of authenticating the mapped and registered status between the mobile phone number and the valid unique identification information to the communication server 250 (840).

The communication server 250 receives the result of authenticating the mapped and registered status between the mobile phone number and the valid unique identification information from the authentication server 200 (845). When the mapped and registered status between the mobile phone number and the valid unique identification information is not authenticated, the communication server 250 requests an error processing of the call reception request information to the emulating device 100 (850), and the emulating device 100 performs an error processing procedure of the call connection request signal through the mobile communication network corresponding to the USIM (810).

Meanwhile, when the mapped and registered status between the mobile phone number and the valid unique identification information is authenticated, the communication server 250 transmits SIP-based call reception request information corresponding to the call reception request information to the program of the user wireless terminal 160 corresponding to the unique identification information mapped with the authenticated mobile phone number via the Internet (855).

The program of the user wireless terminal 160 receives the SIP-based call reception request information via the Internet (860), and waits for the SIP-based call reception for the SIP-based call reception request information (865).

When the program of the user wireless terminal 160 receives the SIP-based call reception request information, the program of the user wireless terminal 160 performs a procedure of connecting the communication server 250 to the Internet-based communication channel (870). Meanwhile, the communication server 250 performs the procedure of transmitting the SIP-based call reception request information (855), and then confirms whether the program of the user wireless terminal 160 receives the SIP-based call reception request information and the Internet-based call channel is connected (875). When the program of the user wireless terminal 160 is connected to the Internet-based communication channel, the communication server 250 performs a procedure of relaying and linking the Internet-based call channel connected to the program of the wireless terminal 160 with the mobile communication-based call channel between the emulating device 100 and the domestic terminal (880), and the emulating device 100 also performs the procedure of relaying and linking the mobile communication-based communication channel between the emulating device 100 and the domestic terminal with the Internet-based communication channel between the programs of the communication server 250 and the wireless terminal 160 (885).

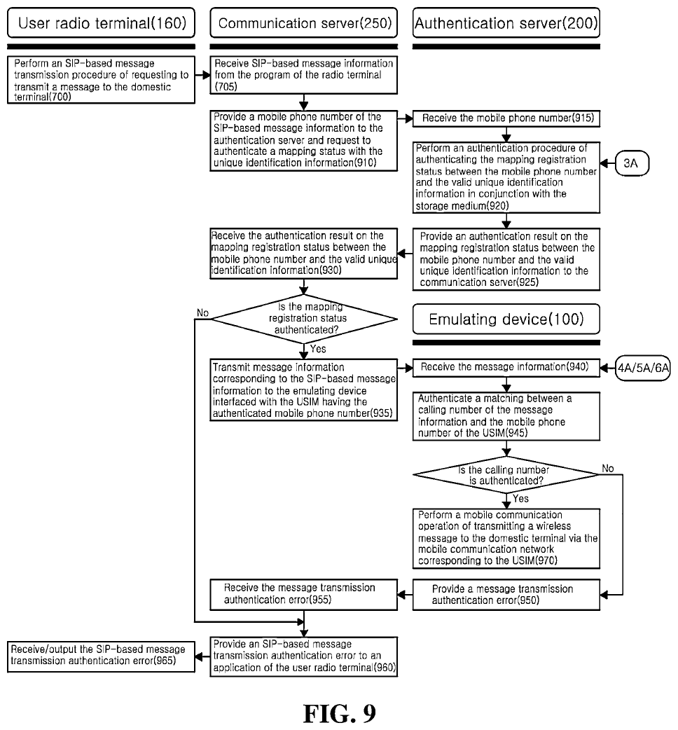

FIG. 9 is a diagram showing a process of emulating a wireless message, which is sent to a domestic terminal through a program of a user wireless terminal 160 located anywhere in the world, into a domestic messaging according to a third embodiment of the present invention.

More particularly, FIG. 9 shows a process when a program of the user wireless terminal 160 located anywhere in the world requests a global messaging of sending a wireless message to a domestic terminal located in the domestic region, of emulating the global messaging as a domestic messaging between a user wireless terminal 160 located in the domestic region and the domestic terminal through the emulating device 100 provided at a domestic base and interfaced to a valid USIM. Those having ordinary skill in the art may infer various implementation methods (in which, for example, some steps are omitted or a sequence is changed) for the above process with reference to and/or modification of the FIG. 9. However, the present invention is described including all the above inferred implementation methods, and the technical features are not limited only to the implementation method shown in FIG. 9.

Referring to FIG. 9, when the program of the user wireless terminal 160 connected to the Internet anywhere in the world performs an SIP-based message sending procedure for requesting a message sending to the domestic terminal (900), the communication server 250 receives the SIP-based message information from the program of the user wireless terminal 160 (905), and provides the mobile phone number corresponding to the calling number of the SIP-based message information to the authentication server 200, to request to authenticate a mapped and registered status between the mobile phone number and valid unique identification information (910).

The authentication server 200 receives the mobile phone number (915), links with the storage medium to perform an authentication procedure of authenticating a mapped and registered status between the mobile phone number included in the SIP-based message information and the valid unique identification information (920), and then provides a result of authenticating the mapped and registered status between the mobile phone number and the valid unique identification information to the communication server 250 (925).

The communication server 250 receives the result of authenticating the mapped and registered status between the mobile phone number and the valid unique identification information from the authentication server 200 (930). When the mapped and registered status between the mobile phone number and the valid unique identification information is not authenticated, the communication server 250 provides an authentication error on the SIP-based message sending to the program of the user wireless terminal 160 (960), and the program of the user wireless terminal 160 receives and outputs the authentication error on the SIP-based message sending (965).

Meanwhile, when the mapped and registered status between the mobile phone number and the valid unique identification information is authenticated, the communication server 250 transmits the message information corresponding to the SIP-based message information to the emulating device 100 interfacing the USIM having the mobile phone number corresponding to the calling number of the SIP-based message information via the Internet (935).

The emulating device 100 subject to a designated authentication procedure receives the message information from the communication server 250 via the Internet (940), and performs an authentication procedure of authenticating whether the calling number of the message information matches the mobile phone number stored in the designated storage area of the USIM interfaced to the USIM interface unit 105 (945). When the calling number of the message information does not match the mobile phone number of the USIM, the emulating device 100 provides an authentication error on the message sending to the communication server 250 (950), and the communication server 250 receives the authentication error on the message sending (955). The communication server 250 provides the authentication error on the SIP-based message sending to the program of the user wireless terminal 160, based on the authentication error on the message sending (960), and the program of the user wireless terminal 160 receives and outputs the authentication error on the SIP-based message sending (965).

Meanwhile, when the calling number of the message information matches the mobile phone number of the USIM, the emulating device 100 perform the mobile communication operation of transmitting the wireless message including the mobile phone number of the USIM as a calling number and the receiving number and the message content of the message information via the mobile communication network corresponding to the USIM (970).

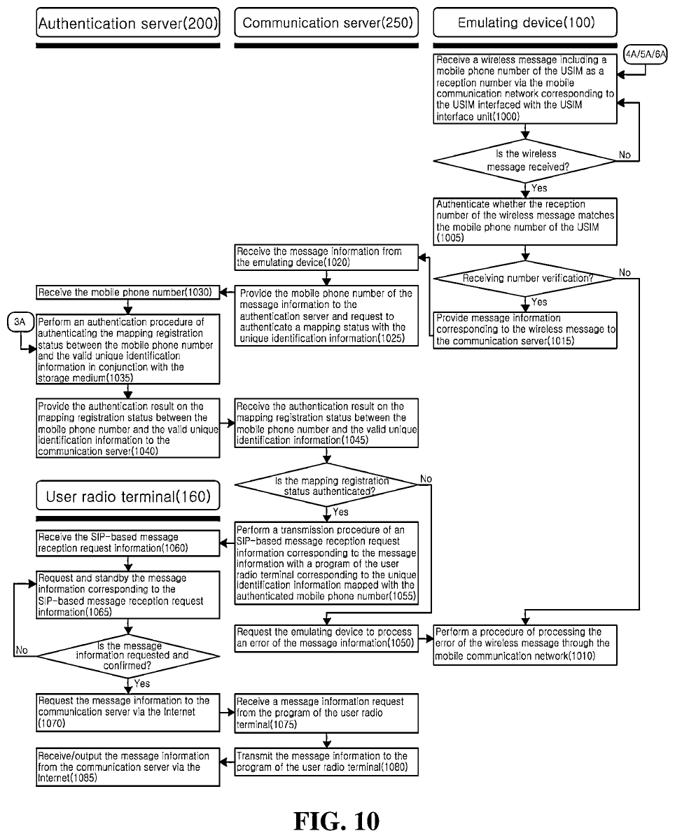

FIG. 10 is a diagram showing a process of emulating a wireless message, which is sent to a user wireless terminal 160 anywhere in the world corresponding to a mobile phone number of USIM through a domestic terminal, into a domestic messaging according to a fourth embodiment of the present invention.

More particularly, FIG. 10 shows a process when a global messaging of sending a wireless message is requested from a domestic terminal located in a domestic region to a user wireless terminal 160 anywhere in the world corresponding to a mobile phone number of the USIM interfaced to the emulating device 100, of emulating the global messaging as a domestic messaging between the domestic terminal located in the domestic region and the user wireless terminal 160 through the emulating device 100 provided at a domestic base and interfaced to a valid USIM. Those having ordinary skill in the art may infer various implementation methods (in which, for example, some steps are omitted or a sequence is changed) for the above process with reference to and/or modification of the FIG. 10. However, the present invention is described including all the above inferred implementation methods, and the technical features are not limited only to the implementation method shown in FIG. 10.

Referring to FIG. 10, when a domestic terminal located in the domestic region transmits a wireless message including a mobile phone number of the USIM interfaced to the emulating device 100 as a receiving number, including a designated phone number of the domestic terminal as a calling number, and including a designated message content, the emulating device 100 subject to a designated authentication procedure receives the wireless message including the mobile phone number of the USIM as a receiving number via the mobile communication network corresponding to the USIM interfaced to the USIM interface unit 105 (1000).

When the wireless message is received, the emulating device 100 performs an authentication procedure of authenticating whether the receiving number of the wireless message matches the mobile phone number stored in the designated storage area of the USIM interfaced to the USIM interface unit 105 (1005). When the receiving number of the wireless message does not match the mobile phone number of the USIM, the emulating device 100 performs an error processing procedure of the wireless message through the mobile communication network corresponding to the USIM (1010).

Meanwhile, when the receiving number of the wireless message matches the mobile phone number of the USIM, the emulating device 100 provides message information corresponding to the wireless message to the communication server 250 via the Internet (1015).

The communication server 250 receives the message information including the mobile phone number of the USIM as a receiving number, including a designated phone number of the domestic terminal as a calling number, and including a designated message content from the emulating device 100 via the Internet (1020), and provides the mobile phone number included in the message information to the authentication server 200, to request to authenticate a mapped and registered status between the mobile phone number and valid unique identification information (1025).

The authentication server 200 receives the mobile phone number (1030), links with the storage medium to perform an authentication procedure of authenticating a mapped and registered status between the mobile phone number included in the message information and the valid unique identification information (1035), and then provides a result of authenticating the mapped and registered status between the mobile phone number and the valid unique identification information to the communication server 250 (1040).

The communication server 250 receives the result of authenticating the mapped and registered status between the mobile phone number and the valid unique identification information from the authentication server 200 (1045). When the mapped and registered status between the mobile phone number and the valid unique identification information is not authenticated, the communication server 250 requests an error processing of the message information to the emulating device 100 (1050), and the emulating device 100 performs an error processing procedure of the wireless message through the mobile communication network corresponding to the USIM (1010).

Meanwhile, when the mapped and registered status between the mobile phone number and the valid unique identification information is authenticated, the communication server 250 performs a procedure of transferring SIP-based message reception request information corresponding to the message information to the program of the user wireless terminal 160 corresponding to the unique identification information mapped with the authenticated mobile phone number via the Internet (1055).

The program of the user wireless terminal 160 receives the SIP-based message reception request information via the Internet (1060), and requests and waits for message information corresponding to the SIP-based message reception request information (1065).

When the message information corresponding to the SIP-based message reception request information is requested through the program of the user wireless terminal 160, the program of the user wireless terminal 160 requests, to the communication server 250 via the Internet, message information (for example, message information that matches specific SIP-based message reception request information, or at least one message information that is not provided to the program of the wireless terminal 160 among message information transferred to the communication server 250 before the specific SIP-based message reception request information) (1070), the communication server 250 receives the message information request from the program of the user wireless terminal 160 via the Internet (1075), and then transmits the message information to the program of the user wireless terminal 160 via the Internet (1080), and the program of the user wireless terminal 160 receives and outputs the message information (1085).

[Reference Numerals]

| | |
|---|---|
| 100: Emulating device | 105: USIM interface unit |
| 110: Radio unit | 115: Antenna unit |
| 120: Mobile communication | 125: Control module |
| processing unit | |
| 130: USIM authentication unit | 135: Information confirmation unit |
| 140: Authentication processing unit | 145: Linking processing unit |
| 150: Communication unit | 155: Access device |
| 160: Wireless terminal | 200: Authentication server |
| 205: Information storage unit | 210: Payment procedure unit |
| 215: Payment confirmation unit | 220: Information registration unit |
| 225: Information receiving unit | 230: Authentication procedure unit |
| 235: Result generating unit | 240: Result providing unit |
| 250: Communication server | 255: Authentication linking unit |
| 260: Terminal linking unit | 265: Device linking unit |

1. A personal emulating device for emulating global phone communication into domestic mobile communication, the personal emulating device comprising:
a USIM interface unit for interfacing with a USIM of a designated standard;
an antenna unit for transmitting and receiving a radio frequency signal of a designated mobile communication standard to and from a base station of a mobile communication network corresponding to the USIM interfaced to the USIM interface unit;
a radio unit configured to perform a signal processing operation for transmitting and receiving the radio frequency signal of the designated mobile communication standard to and from the base station of the mobile communication network corresponding to the USIM interfaced to the USIM interface unit;
a mobile communication processing unit configured to perform a mobile communication operation procedure equivalent to a mobile communication operation of a mobile communication terminal interfacing with the USIM interfaced to the USIM interface unit; and
a communication unit connected to the Internet via a designated Internet access device, and comprising:
a control module including:
a USIM authentication unit for authenticating whether a valid USIM validly issued through a designated mobile communication company is interfaced to the USIM interface unit;
an information confirmation unit, when the valid USIM is interfaced to the USIM interface unit, for confirming identification information including a mobile phone number stored in a designated storage area of the USIM interfaced to the USIM interface unit;
an authentication processing unit for providing the mobile phone number (or the identification information including the mobile phone number) of the USIM to a designated authentication server through the communication unit to request authentication whether the mobile phone number of the USIM is mapped and registered with valid unique identification information, and receive an authentication result of authenticating a mapped and registered state between the mobile phone number of the USIM and the valid unique identification information from the authentication server; and
a linking processing unit, when the mapped and registered status between the mobile phone number of the USIM and the valid unique identification information is authenticated, for linking a designated SIP operation performed in conjunction with an SIP function of the program of the user wireless terminal corresponding to the authenticated unique identification information and an SIP processing function of the designated communication server with a designated mobile communication operation of the mobile communication processing unit, or linking a designated mobile communication operation performed through the mobile communication processing unit with a designated SIP operation performed in conjunction with an SIP function of the program of the user wireless terminal corresponding to the authenticated unique identification information and an SIP processing function of the designated communication server.

2. The personal emulating device of claim 1, wherein the USIM interface unit performs a selective power on or off function for a USIM inserted into a USIM insertion unit, and an interface function including designated i (i≥1) instruction injection and response reception to implement a USIM function of the USIM when power is applied to the USIM inserted into the USIM insertion unit.

3. The personal emulating device of claim 1, wherein the USIM interface unit, the mobile communication processing unit, the radio unit, and the antenna unit, when the valid USIM is interfaced to the USIM interface unit, emulates a mobile communication terminal to which the USIM is interfaced to a mobile communication network corresponding to the USIM.

4. The personal emulating device of claim 1, wherein the USIM interface unit, the mobile communication processing unit, the radio unit, the antenna unit, and the SIP processing function of the communication server, when the valid USIM is interfaced to the USIM interface unit, virtualizes the program of the user wireless terminal linked with the SIP processing function of the communication server into a mobile communication terminal connected to the mobile communication network in a domestic region which operates a mobile communication network corresponding to the USIM.
